(19) United States
(12) Patent Application Publication
(10) Pub. No.: US 2009/0244778 A1
(43) Pub. Date: Oct. 1, 2009

(54) HEAD SUSPENSION ASSEMBLY AND CARRIAGE ASSEMBLY

(75) Inventors: Shin-ya Hasegawa, Kawasaki (JP); Wataru Odajima, Kawasaki (JP); Fumihiro Tawa, Kawasaki (JP); Yoshifumi Mizoshita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/485,669

(22) Filed: Jun. 16, 2009

Related U.S. Application Data
(63) Continuation of application No. PCT/JP2007/075217, filed on Dec. 27, 2007.

(30) Foreign Application Priority Data
Dec. 27, 2006 (JP) 2006-353458

(51) Int. Cl. G11B 5/60

(52) U.S. Cl. 360/234; G9B/5.229

(57) ABSTRACT

A head suspension assembly comprising: a head suspension; a head slider having the medium-opposed surface opposed to a storage medium, the head slider having the supported surface received on the head suspension, the supported surface being defined at the farside of the medium-opposed surface; an electromagnetic transducer embedded in the medium-opposed surface of the head slider; a light waveguide incorporated in the head slider, the light waveguide extending from the supported surface to the medium-opposed surface; and an optical element interposed between the supported surface and the head suspension, wherein the optical element defines: a light-collecting surface configured to collect light input into the optical element in parallel with the supported surface; and a light-reflective surface configured to reflect the light at a predetermined angle so as to direct the light to the light waveguide.

### CROSS-REFERENCE TO RELATED APPLICATION

This application is a continuing application, filed under 35 U.S.C. §111(a), of International Application PCT/JP2007/075217, filed on Dec. 27, 2007, the contents of which are incorporated herein by reference. International Application PCT/JP2007/075217 is based upon and claims the benefit of priority from the prior Japanese Patent Application No. 2006-353458 filed on Dec. 27, 2006, the entire contents of which are also incorporated herein by reference.

### FIELD

The embodiments discussed herein are related to a storage apparatus applying heat to a magnetic recording layer in a storage medium for at least writing operation of magnetic bit data.

### BACKGROUND

A so-called heat assisted recording method is employed for a hard disk drive, HDD, to avoid thermal fluctuation, for example. A head slider has a prism attached to its supported surface defined at the farside of the medium-opposed surface, as disclosed in FIGS. 11 and 12 of Japanese Patent Application Publication No. 2003-067901. The prism receives an optical fiber. A lens is attached to the outflow end surface of the head slider. The prism defines a light-reflective surface to direct a light beam to the lens.

Light is input into the prism through the optical fiber. The light-reflective surface reflects the light so that the light is directed to the lens. The light is collected at the lens. The light is supplied to a magnetic recording disk from the lens. The temperature of a magnetic recording layer increases. The magnetic coercive force of the magnetic recording layer is reduced. An electromagnetic transducer on the head slider operates to write magnetic bit data into the magnetic recording layer at this moment. When the temperature of the magnetic recording layer returns to normal or room temperature, the magnetic coercive force of the magnetic recording layer increases. The magnetic bit data is thus reliably held.

The prism and the lens are attached to the head slider. It is required to position the prism and the lens relative to the head slider for adjusting the focal point of light supplied to the magnetic recording layer. Simultaneously, it is also required to slightly adjust the relative positions of the prism and the lens to each other. The assembling process becomes complicated.

### SUMMARY

According to a first aspect of the present invention, there is provided a head suspension assembly comprising: a head suspension; a head slider having the medium-opposed surface opposed to a storage medium, the head slider having the supported surface received on the head suspension, the supported surface being defined at the farside of the medium-opposed surface; an electromagnetic transducer embedded in the medium-opposed surface of the head slider; a light waveguide incorporated in the head slider, the light waveguide extending from the supported surface to the medium-opposed surface; and an optical element interposed between the supported surface and the head suspension, wherein the optical element defines: a light-collecting surface configured to collect light input into the optical element in parallel with the supported surface; and a light-reflective surface configured to reflect the light at a predetermined angle so as to direct the light to the light waveguide.

According to a second aspect of the present invention, there is provided a carriage assembly comprising: a carriage arm pivotally supported on a support shaft; a pair of head suspensions attached to the tip end of the carriage arm; head sliders having the medium-opposed surfaces opposed to storage media, respectively, the head sliders having the supported surfaces received on the head suspensions, respectively, the supported surfaces being defined at the farside of the medium-opposed surfaces, respectively; electromagnetic transducers embedded in the medium-opposed surfaces of the head sliders, respectively; light waveguides incorporated in the head sliders, respectively, the light waveguides extending from the supported surfaces to the medium-opposed surfaces, respectively; optical elements interposed between the supported surfaces and the head suspensions, respectively, the optical elements having light-collecting surfaces receiving the incidence of light to direct the light to the light waveguides, respectively; an opening formed in the carriage arm; a single support body placed in the opening, and a pair of light sources supported on the support body, the light sources supplying light respectively to the light-collecting surfaces of the optical elements.

According to a third aspect of the present invention, there is provided a storage apparatus comprising: an enclosure; a carriage arm incorporated in the enclosure, the carriage arm pivotally supported on a support shaft; a pair of head suspensions attached to the tip end of the carriage arm; head sliders having the medium-opposed surfaces opposed to a storage medium, respectively, the head sliders having the supported surfaces received on the head suspensions, respectively, the supported surfaces being defined at the farside of the medium opposed surfaces, respectively; electromagnetic transducers embedded in the medium-opposed surfaces of the head sliders, respectively; light waveguides incorporated in the head sliders, respectively, the light waveguides extending from the supported surfaces to the medium-opposed surfaces, respectively; optical elements interposed between the supported surfaces and the head suspensions, respectively, the optical elements having light-collecting surfaces receiving the incidence of light to direct the light to the light waveguides, respectively; an opening formed in the carriage arm; a single support body placed in the opening; and a pair of light sources supported on the support body, the light sources supplying light respectively to the light-collecting surfaces of the optical elements.

According to a fourth aspect of the present invention, there is provided a method of making a head slider assembly, comprising: molding a molded product, elongated in the lateral direction, with a die so that light-collecting surfaces are arranged in a row at predetermined intervals on the edge of the molded product along a reference surface extending on the molded product in the lateral direction; subjecting the edge of the molded product, at the farside of the edge along the reference surface, to grinding process to form a light-reflective surface extending in the lateral direction, the light-reflective surface intersecting with the reference surface by a predetermined inclination angle; attaching to the reference surface of the molded product an elongated wafer bar including head sliders in a row at the predetermined intervals; and grinding the molded product on the back side of the reference surface to form a surface parallel to the reference surface.

According to a fifth aspect of the present invention, there is provided a head suspension assembly comprising: a head suspension; a head slider having the medium-opposed surface opposed to a storage medium, the head slider having the supported surface received on the head suspension, the supported surface being defined at the farside of the medium-opposed surface; an electromagnetic transducer embedded in the medium-opposed surface of the head slider; a light waveguide incorporated in the head slider, the light waveguide extending from the supported surface to the medium-opposed surface; and an optical element interposed between the supported surface and the head suspension, wherein the optical element defines: a light-collecting surface configured to collect light input into the optical element in parallel with the supported surface; and a light-reflective surface configured to reflect the light at a predetermined angle to direct the light to the light waveguide, the light having been input into the optical element through the light-collecting surface.

According to a sixth aspect of the present invention, there is provided a head suspension assembly comprising: a head suspension; a head slider having the medium-opposed surface opposed to a storage medium, the head slider having the supported surface received on the head suspension, the supported surface being defined at the farside of the medium-opposed surface; an electromagnetic transducer embedded in the medium-opposed surface of the head slider; a light waveguide incorporated in the head slider, the light waveguide extending from the supported surface to the medium-opposed surface; an optical element interposed between the supported surface and the head suspension; a light-reflective surface defined in the optical element, the light-reflective surface reflecting light, having been input in parallel with the supported surface, at a predetermined angle to direct the light to the light waveguide; and a gradient index lens supplying to the optical element light passing through the gradient index lens.

According to a seventh aspect of the present invention, there is provided a head suspension assembly comprising: a head suspension; a head slider having the medium-opposed surface opposed to a storage medium, the head slider having the supported surface received on the head suspension, the supported surface being defined at the farside of the medium-opposed surface; an electromagnetic transducer embedded in the medium-opposed surface of the head slider; a light waveguide incorporated in the head slider, the light waveguide extending from the supported surface to the medium-opposed surface; a sheet clad received on the head suspension; and a core embedded in the sheet clad, the core reaching the supported surface of the head slider, the core configured to direct light to the light waveguide of the head slider.

According to an eight aspect of the present invention, there is provided a head suspension assembly comprising: a head suspension; a head slider having the medium-opposed surface opposed to a storage medium, the head slider having the supported surface received on the head suspension, the supported surface being defined at the farside of the medium-opposed surface; an electromagnetic transducer embedded in the medium-opposed surface of the head slider; a light waveguide incorporated in the head slider, the light waveguide extending from the supported surface to the medium-opposed surface; an optical element interposed between the supported surface and the head suspension; a sheet clad received on the head suspension; and a core embedded in the clad.

According to a ninth aspect of the present invention, there is provided a head suspension assembly comprising: a head suspension; a flexure received on the head suspension; a head slider having the medium-opposed surface opposed to a storage medium, the head slider having the supported surface received on a support plate of the flexure, the supported surface being defined on the farside of the medium-opposed surface; an electromagnetic transducer embedded in the medium-opposed surface of the head slider; a light waveguide incorporated in the head slider, the light waveguide extending from the supported surface to the medium-opposed surface; an optical element interposed between the supported surface and the support plate of the flexure; and a light source received on the support plate of the flexure to supply light to the optical element.

According to a tenth aspect of the present invention, there is provided a carriage assembly comprising: a carriage block pivotally supported on a support shaft; a carriage arm defined in the carriage block; a pair of head suspensions attached to the tip end of the carriage arm; head sliders having the medium-opposed surfaces opposed to a storage medium, respectively, the head sliders having the supported surfaces received on the associated one of the head suspensions, the supported surfaces being defined on the farside of the medium-opposed surfaces, respectively; an electromagnetic transducer embedded in the medium-opposed surface of the head slider; a light waveguide incorporated in the head slider, the light waveguide extending from the supported surface to the medium-opposed surface; sheet clads received on the head suspensions, respectively; cores embedded in the clads; and a light source attached to the carriage block, the light source supplying light to the light-input surfaces of the cores.

The object and advantages of the embodiment will be realized and attained by means of the elements and combinations particularly pointed out in the appended claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a plan view schematically depicting a hard disk drive as a specific example of a storage apparatus;

FIG. 2 is an enlarged partial plan view schematically depicting a carriage assembly according to a first embodiment;

FIG. 3 is an enlarged partial perspective view schematically depicting a light source and a support body;

FIG. 4 is an enlarged partial perspective view schematically depicting a head slider assembly;

FIG. 5 is a perspective view schematically depicting a head slider according to a specific example;

FIG. 6 is an enlarged front view of an electromagnetic transducer;

FIG. 7 is a sectional view taken along the line 7-7 in FIG. 6;

FIG. 8 is a partial exploded view schematically depicting a light waveguide and an optical element;

FIG. 9 is a plan view schematically depicting the optical element;

FIG. 10 is a side view schematically depicting the optical element;

FIG. 11 is a partial sectional view schematically depicting the carriage assembly opposed to storage media;

FIG. 12 is a perspective view schematically depicting a molded product;

FIG. 13 is a perspective view schematically depicting that a light-reflective surface is formed in the molded product;

FIG. 14 is a perspective view schematically depicting that a wafer bar is attached on a reference surface defined in the molded product;

FIG. 15 is a perspective view schematically depicting that the wafer bar is positioned relative to the molded product;

FIG. 16 is a perspective view schematically depicting that a parallel surface is formed in the molded product;

FIG. 17 is a perspective view schematically depicting that the head slider assemblies are cut out of the molded product and the wafer bar;

FIG. 18 is a plan view schematically depicting an optical element according to a modification;

FIG. 19 is a side view schematically depicting the optical element;

FIG. 20 is a sectional view schematically depicting a carriage assembly according to a second embodiment;

FIG. 21 is a sectional view schematically depicting relative positions of light sources and coupling lenses;

FIG. 22 is a sectional view schematically depicting a carriage assembly according to a third embodiment;

FIG. 23 is a perspective view schematically depicting that light-reflective surfaces are formed in a coupler element;

FIG. 24 is a sectional view schematically depicting a carriage assembly according to a fourth embodiment;

FIG. 25 is a sectional view schematically depicting a carriage assembly according to a fifth embodiment;

FIG. 26 is a perspective view schematically depicting an optical fiber and the coupler element;

FIG. 27 is a sectional view schematically depicting a carriage assembly according to a sixth embodiment;

FIG. 28 is a sectional view schematically depicting a carriage assembly according to a seventh embodiment;

FIG. 29 is a sectional view schematically depicting a carriage assembly according to an eighth embodiment;

FIG. 30 is a sectional view schematically depicting a carriage assembly according to a ninth embodiment;

FIG. 31 is a perspective view schematically depicting an optical element according to a specific example;

FIG. 32 is a plan view schematically depicting the optical element;

FIG. 33 is a side view schematically depicting the optical element;

FIG. 34 is a perspective view schematically depicting a die;

FIG. 35 is a vertically sectional view schematically depicting the die;

FIG. 36 is a partial sectional view schematically depicting an optical element according to a modification;

FIG. 37 is a perspective view schematically depicting the optical element;

FIG. 38 is a graph showing a relationship between the numerical aperture and the coupling efficiency;

FIG. 39 is a partial sectional view schematically depicting an optical element according to another modification;

FIG. 40 is a perspective view schematically depicting an optical element according to another modification;

FIG. 41 is a partial sectional view schematically depicting an optical element according to another modification;

FIG. 42 is a perspective view schematically depicting the optical element;

FIG. 43 is a partial sectional view schematically depicting an optical element according to another modification;

FIG. 44 is a perspective view schematically depicting the optical element;

FIG. 45 is a vertically sectional view schematically depicting a die;

FIG. 46 is a perspective view schematically depicting an optical element according to another modification;

FIG. 47 is a partial sectional view schematically depicting the optical element;

FIG. 48 is a plan view schematically depicting a carriage assembly according to a tenth embodiment;

FIG. 49 is an enlarged partial sectional view taken along the line 49-49 in FIG. 48;

FIG. 50 is an enlarged partial sectional view schematically depicting the light source and the light waveguide;

FIG. 51 is an enlarged partial sectional view schematically depicting the light waveguides and the optical elements;

FIG. 52 is an enlarged partial sectional view schematically depicting a light waveguide according to a modification;

FIG. 53 is a plan view schematically depicting a carriage assembly according to an eleventh embodiment;

FIG. 54 is an enlarged partial sectional view schematically depicting the light waveguides and the optical elements;

FIG. 55 is an enlarged partial exploded view schematically depicting the light waveguide and the optical element;

FIG. 56 is an enlarged partial sectional view schematically depicting the light waveguide;

FIG. 57 is an enlarged partial sectional view schematically depicting a process of forming the light waveguide;

FIG. 58 is an enlarged partial sectional view schematically depicting the process of forming the light waveguide;

FIG. 59 is an enlarged partial sectional view schematically depicting the process of forming the light waveguide;

FIG. 60 is a plan view schematically depicting a carriage assembly according to a twelfth embodiment;

FIG. 61 is an enlarged partial plan view schematically depicting a light waveguide according to another specific example;

FIG. 62 is an enlarged partial sectional view schematically depicting the light source and the light waveguide;

FIG. 63 is a plan view schematically depicting a carriage assembly according to a thirteenth embodiment;

FIG. 64 is a view schematically depicting an optical module according to a specific example;

FIG. 65 is a view schematically depicting an optical module according to another specific example;

FIG. 66 is a view schematically depicting an optical module according to another specific example;

FIG. 67 is an enlarged partial perspective view schematically depicting a light waveguide according to a modification;

FIG. 68 is an enlarged partial sectional view schematically depicting the light waveguide;

FIG. 69 is an enlarged partial sectional view schematically depicting a light waveguide according to another modification;

FIG. 70 is an enlarged partial sectional view schematically depicting a light waveguide according to another modification; and

FIG. 71 is an enlarged partial exploded view schematically depicting a carriage assembly according to a fourteenth embodiment.

### DESCRIPTION OF EMBODIMENTS

Description will be made below on embodiments of the present invention with reference to the attached drawings.

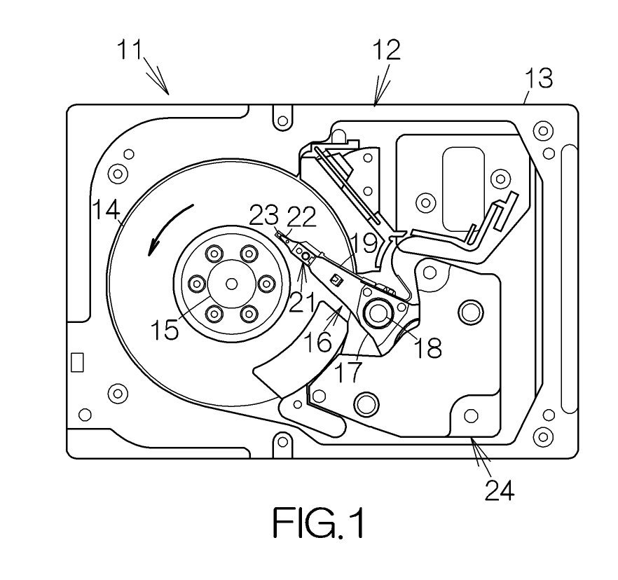

FIG. 1 schematically depicts the inner structure of a hard disk drive, HDD, 11 as an example of a storage medium drive or a storage apparatus. The hard disk drive 11 includes a housing or enclosure 12. The enclosure 12 includes a box-shaped enclosure base 13 and an enclosure cover, not depicted. The enclosure base 13 defines an inner space in the form of a flat parallelepiped, for example. The enclosure base 13 may be made of a metallic material such as aluminum, for example. Molding process may be employed to form the enclosure base 13. The enclosure cover is coupled to the enclosure base 13 to close the opening of the enclosure base 13. An inner space is defined between the enclosure base 13 and the enclosure cover. Pressing process may be employed to form the enclosure cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like. A so-called perpendicular magnetic recording disk is employed as the magnetic recording disk or disks 14.

A carriage assembly 16 is also enclosed in the enclosure 12. The carriage assembly 16 includes a carriage block 17. The carriage block 17 is supported on a vertical support shaft 18 for relative rotation. Rigid carriage arms 19 are defined in the carriage block 17. The carriage arms 19 extend in the horizontal direction from the vertical support shaft 18. The carriage block 17 may be made of aluminum, for example. Molding process may be employed to form the carriage block 17, for example. As conventionally known, a single one of the carriage arm 19 is placed between the adjacent ones of the magnetic recording disks 14.

A head suspension assembly 21 is attached to the front or tip end of each one of the carriage arms 19. The head suspension assembly 21 includes a head suspension 22. The head suspension 22 extends forward from the tip end of the carriage arm 19. A flying head slider 23 is supported on the front or tip end of the head suspension 22. The flying head slider 23 is opposed to the surface of the magnetic recording disk 14. As conventionally known, the carriage arm 19 supports two of the head suspensions 22 between the adjacent ones of the magnetic recording disks 14.

A head element or electromagnetic transducer is mounted on the flying head slider 23. The electromagnetic transducer will later be described in detail. An urging force is applied to the flying head slider 23 from the head suspension 22 toward the surface of the magnetic recording disk 14. When the magnetic recording disk 14 rotates, the flying head slider 23 is allowed to receive airflow generated along the surface of the magnetic recording disk 14. The airflow serves to generate a positive pressure or a lift. The lift is balanced with the urging force of the head suspension 22 so that the flying head slider 23 keeps flying above the surface of the magnetic recording disk 14 during the rotation of the magnetic recording disk 14 at a higher stability.

A power source such as a voice coil motor, VCM, 24 is connected to the carriage block 17. The voice coil motor 24 serves to drive the carriage block 17 around the vertical support shaft 18. The rotation of the carriage block 17 allows the carriage arms 19 and the head suspensions 22 to swing. When the carriage arm 19 swings around the vertical support shaft 18 during the flight of the flying head slider 23, the flying head slider 23 is allowed to move across the surface of the magnetic recording disk 14 in the radial direction of the magnetic recording disk 14. The electromagnetic transducer on the flying head slider 23 can thus be positioned right above a target recording track on the magnetic recording disk 14.

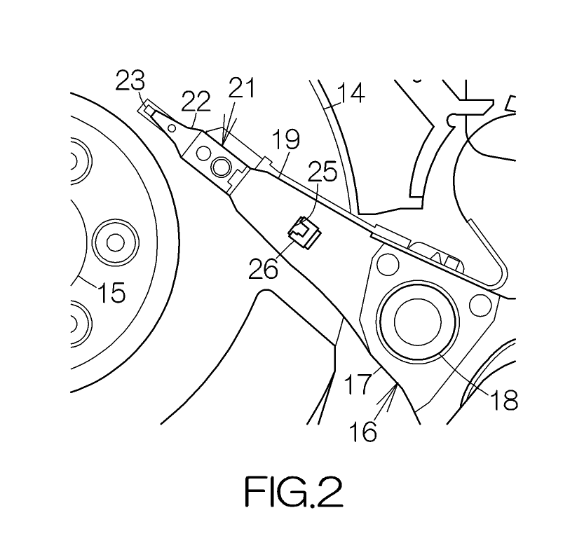

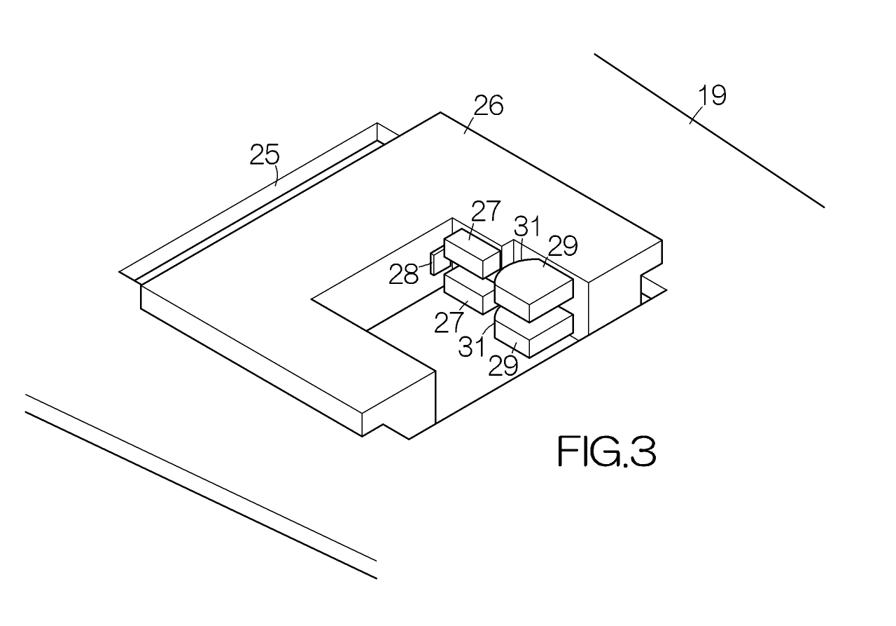

FIG. 2 schematically depicts the carriage assembly 16 according to a first embodiment. An opening 25 is formed in each one of the carriage arms 19 in the carriage assembly 16. A single support member 26 is placed in the opening 25. As depicted in FIG. 3, a pair of light sources, namely laser diode (LD) chips 27, are mounted on the support member 26 in the carriage arm 19 placed between the adjacent ones of the magnetic recording disks 14. The LD chips 27 emit light toward the tip end or front end of the carriage arm 19. The LD chips 27 may be cut out of a wafer. A light detecting element 28 is supported at a position adjacent to the LD chips 27. The light detecting element 28 serves to keep the intensity of light emitted from the LD chips 27 constant based on the temperature in the hard disk drive 11. A wiring, not depicted, is utilized to supply electric power to the LD chips 27 and the light detecting element 28. The wiring may be attached to the carriage arm 19.

A pair of coupling lenses 29 is supported on the support member 26. The coupling lenses 29 are placed in front of the LD chips 27, respectively. A light-collecting surface 31 is defined in each one of the coupling lenses 29. The light-collecting surface 31 has a predetermined curvature. The light-collecting surface 31 is opposed to the front end of the LD chip 27 at a distance. The light-collecting surface 31 serves to convert the light emitted from the LD chip 27 into a parallel beam or a converging beam. It should be noted that the uppermost and lowermost ones of the carriage arms 19 each support a single head suspension 22. The uppermost and lowermost ones of the carriage arms 19 each have a single LD chip 27 and a single coupling lens 29 supported on the support member 26.

Here, the wavelength of the light emitted from the LD chip 27 is set at approximately 660 nm. The light of the LD chip 27 spreads over an area within the spreading angle of 18 degrees. The focal length of the coupling lens 29 may be set at 0.75 mm for establishment of a parallel beam. The focal length of the coupling lens 29 may be set at 2.00 mm for establishment of a converging beam. The coupling lens 29 in this manner serves to generate the parallel beam or converging beam enabling establishment of a spot having the diameter of 400 μm approximately.

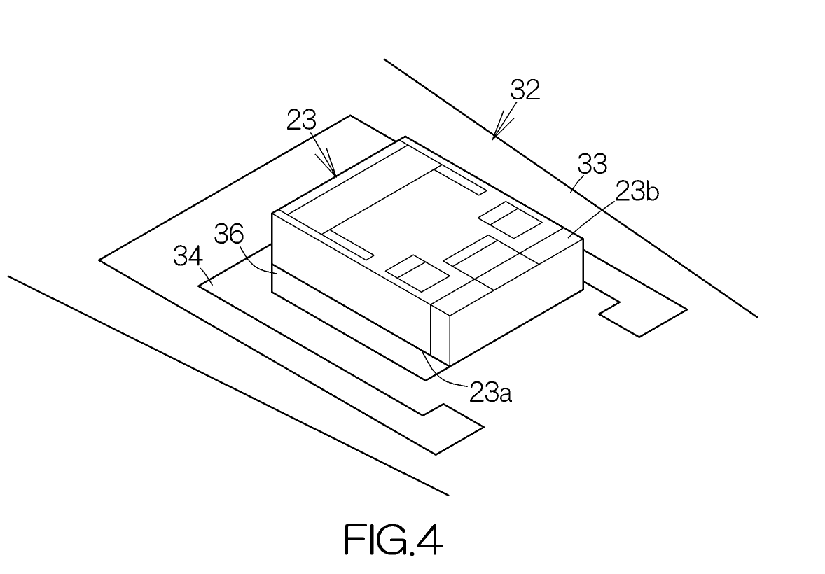

As depicted in FIG. 4, the flying head slider 23 is supported on a flexure 32. The flexure 32 includes a fixation plate 33 supported on the head suspension 22. A support plate 34 is connected to the fixation plate 33. The supported surface 23a of the flying head slider 23 is received on the surface of the support plate 34. The medium-opposed surface 23b is defined on the flying head slider 23 at the farside of the supported surface 23a. The fixation plate 33 and the support plate 34 may be formed out of a plate of a leaf spring material. The leaf spring material may be made of a stainless steel having a constant thickness, for example. The attitude of the support plate 34, namely the flying head slider 23, can be changed relative to the fixation plate 33.

An optical element, namely a coupler element 36, is interposed between the supported surface 23a of the flying head slider 23 and the support plate 34. The coupler element 36 may be bonded to the supported surface 23a and the support plate 34 with an adhesive. The coupler element 36 may be made of a transparent glass material or a transparent plastic material. Molding process may be employed to form the coupler element 36. Sulfur hexafluoride (SF6) may be employed as the glass material, for example. SF6 has the index of refraction equal to 1.7956. Injection molding process may be employed to form the coupler element 39 from the plastic material, for example. The coupler element 36 may have the length of 0.80 mm, the width of 0.60 mm and the thickness of 0.23 mm, approximately, for example. The flying head slider 23 and the coupler element 36 in combination establish the head slider assembly.

FIG. 5 schematically depicts a specific example of the flying head slider 23. The flying head slider 23 includes a slider body 41 in the form of a flat parallelepiped, for example. A non-magnetic insulating film or head protection film 42 is overlaid on the outflow or trailing end surface of the slider body 41. The aforementioned electromagnetic transducer 43 is incorporated in the head protection film 42.

The slider body 41 may be made of a hard non-magnetic material such as Al₂O₃—TiC. The head protection film 42 is made of a relatively soft non-magnetic insulating material such as Al₂O₃ (alumina). The slider body 41 opposes the medium-opposed surface 23b to the magnetic disk 14 at a distance. A flat base surface 45 as a reference surface is defined in the medium-opposed surface 23b. When the magnetic recording disk 14 rotates, airflow 46 flows along the medium-opposed surface 23b from the inflow or front end toward the outflow or rear end of the slider body 41.

A front rail 47 is formed in the medium-opposed surface 23b of the slider body 41. The front rail 47 stands upright from the base surface 45 near the inflow end of the slider body 41. The front rail 47 extends along the inflow end of the base surface 45 in the lateral direction of the slider body 41. A rear rail 48 is likewise formed in the medium-opposed surface 23b of the slider body 41. The rear rail 48 stands upright from the base surface 45 near the outflow end of the slider body 41. The rear rail 48 is placed at the intermediate position in the lateral direction of the slider body 41.

A pair of auxiliary rear rails 49, 49 is likewise formed in the medium-opposed surface 23b of the slider body 41. The auxiliary rear rails 49, 49 stand upright from the base surface 45. The auxiliary rear rails 49, 49 are placed along the side edges of the base surface 45, respectively. The auxiliary rear rails 49, 49 are thus distanced from each other in the lateral direction of the slider body 41. The rear rail 48 is placed in a space between the auxiliary rear rails 49, 49.

Air bearing surfaces 51, 52, 53, 53 are defined on the top surfaces of the front rail 47, the rear rail 48 and the auxiliary rear rails 49, 49, respectively. Steps 54, 55, 56 are defined at the inflow ends of the air bearing surfaces 51, 52, 53, respectively. The steps 54, 55, 56 connect the air bearing surfaces 51, 52, 53 to the top surfaces of the rails 47, 48, 49, respectively. The medium-opposed surface 23b of the flying head slider 23 receives the airflow 46 generated along the rotating magnetic recording disk 14. The steps 54, 55, 56 serve to generate a large positive pressure or lift at the air bearing surfaces 51, 52, 53, respectively. In addition, a large negative pressure is generated behind the front rail 47. The negative pressure is balanced with the lift for establishment of a predetermined flying attitude of the flying head slider 23. It should be noted that the flying head slider 23 may take any shape or form different from the described one.

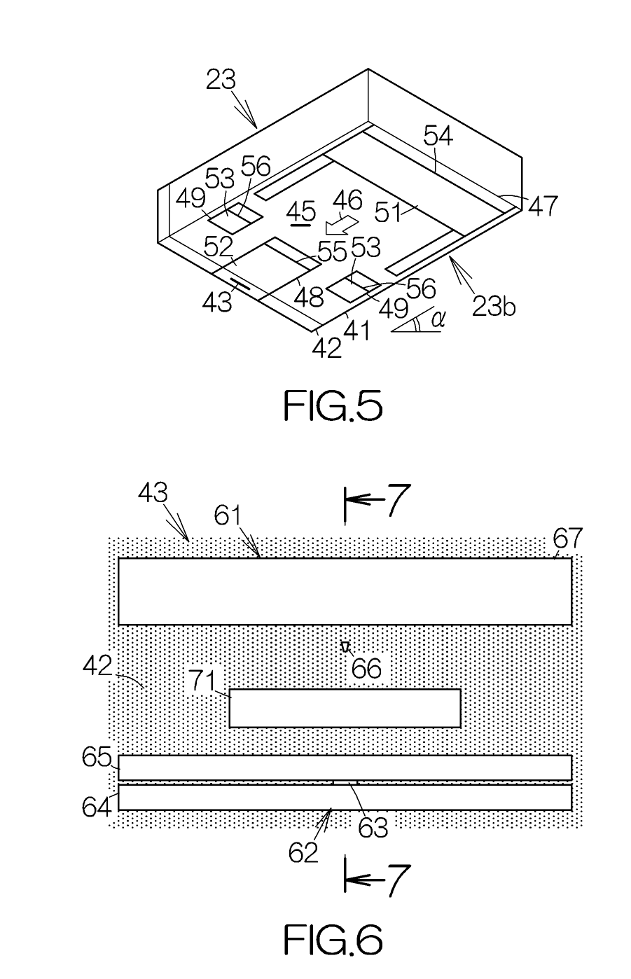

FIG. 6 depicts the electromagnetic transducer 43 in detail. The electromagnetic transducer 43 includes a write head element, namely a single pole head 61, and a read head element 62. The single pole head 61 is located at a position downstream of the read head element 62 in the head protection film 42. As conventionally known, the single pole head 61 utilizes a magnetic field induced at a magnetic coil to write magnetic bit data into the magnetic recording disk 14, for example. A magnetoresistive (MR) element such as a giant magnetoresistive (GMR) element, a tunnel-junction magnetoresistive (TMR) element, or the like, may be employed as the read head element 62. As conventionally known, the read head element 62 is usually allowed to induce variation in the electric resistance in response to the inversion of polarization in the magnetic field applied from the magnetic recording disk 14. This variation in the electric resistance is utilized to detect magnetic bit data.

The single pole head 61 and the read head element 62 are embedded in the head protection film 42. The read head element 62 includes a magnetoresistive film 63, such as a tunnel-junction film, interposed between a pair of electrically-conductive layers, namely a lower shielding layer 64 and an upper shielding layer 65. The lower shielding layer 64 and the upper shielding layer 65 may be made of a magnetic material such as FeN, NiFe, or the like. A space between the lower and upper shielding layers 64, 65 serves to determine a linear resolution of magnetic recordation on the magnetic recording disk 14 along the recording track.

The single pole head 61 includes a main magnetic pole 66 and an auxiliary magnetic pole 67. The main magnetic pole 66 and the auxiliary magnetic pole 67 has the tip ends exposed at the air bearing surface 52, respectively. The main magnetic pole 66 and the auxiliary magnetic pole 67 may be made of a magnetic material such as FeN, NiFe, or the like. Referring also to FIG. 7, a magnetic coil, namely a thin film coil 68, is formed between the main magnetic pole 66 and the auxiliary magnetic pole 67. A connecting piece 69 enables a magnetic connection between the rear end of the main magnetic pole 66 and the auxiliary magnetic pole 67 at the center of the thin film coil 68. The main magnetic pole 66, the auxiliary magnetic pole 67 and the connecting piece 69 in combination establish a magnetic core extending through the center of the thin film coil 68.

A light waveguide, namely a core 71, is embedded in the head protection film 42 between the single pole head 61 and the read head element 62. The single pole head 61, the read head 62 and the core 71 respectively have the centerlines, aligned on a single straight line, in the direction of the core width. The core 71 may be made of TiO₂ having the index of refraction equal to 2.4, for example. The core 71 extends from the supported surface 23a of the flying head slider 23 to the medium-opposed surface 23b of the flying head slider 23, that is, the air bearing surface 52. The front end of the core 71 is exposed at the air bearing surface 52. The width of the core 71 gets narrower as a position gets closer to the air bearing surface 52 from the supported surface 23a. Since the head protection film 42 has a smaller index of refraction than the core 71, the head protection film 42 serves as a clad.

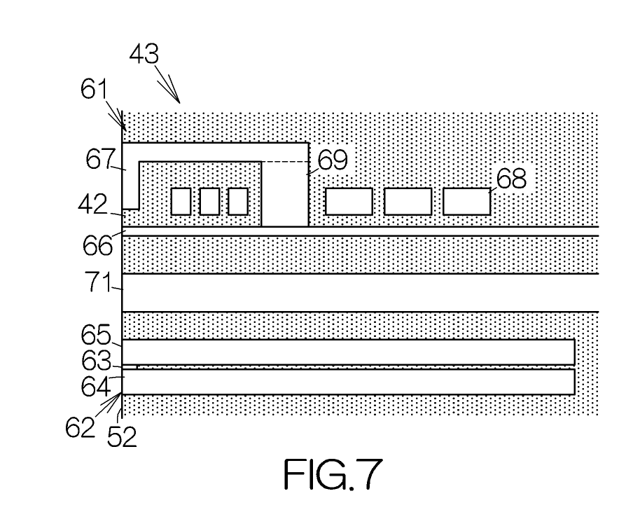

As depicted in FIG. 8, the coupler element 36 has a light-collecting surface 72 within its end surface standing upright from the surface of the support plate 34. The light-collecting surface 72 is opposed to the LD chips 27. The light-collecting surface 72 is configured to receive light running in parallel with the supported surface 23a of the flying head slider 23. The light-collecting surface 72 serves to collect the light. Here, the light-collecting surface 72 may serve as an isotropic lens. The curvature of the light-collecting surface 72 is set at 0.56 mm, for example. The coupler element 36 has a light-reflective surface 73 at the farside of the light-collecting surface 72. The light-reflective surface 73 is opposed to the light-collecting surface 72. The light-reflective surface 73 is defined along an imaginary plane intersecting with the surface of the support plate 34 by an inclination angle of 45 degrees, for example. The light-reflective surface 73 serves to reflect light within the coupler element 36.

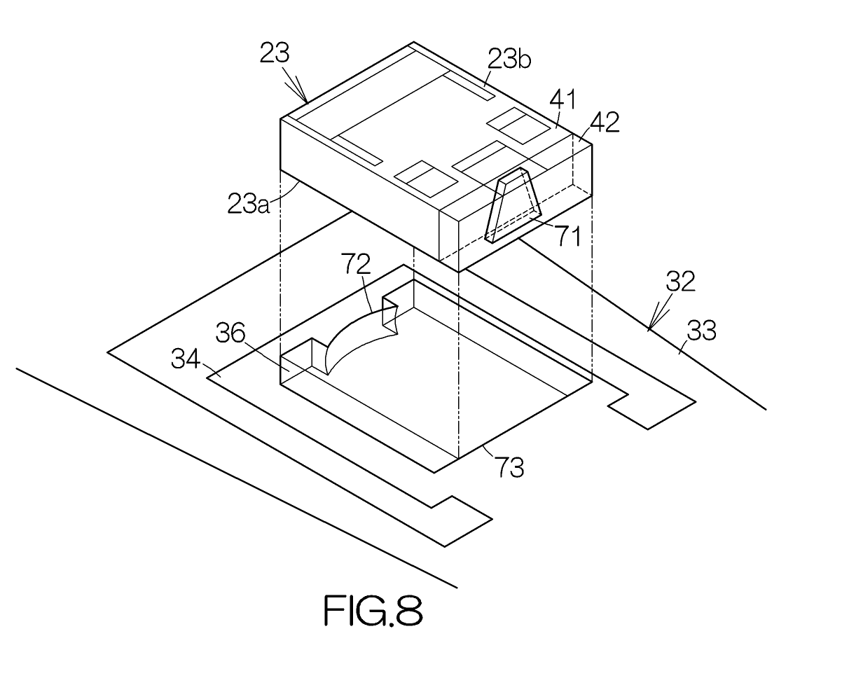

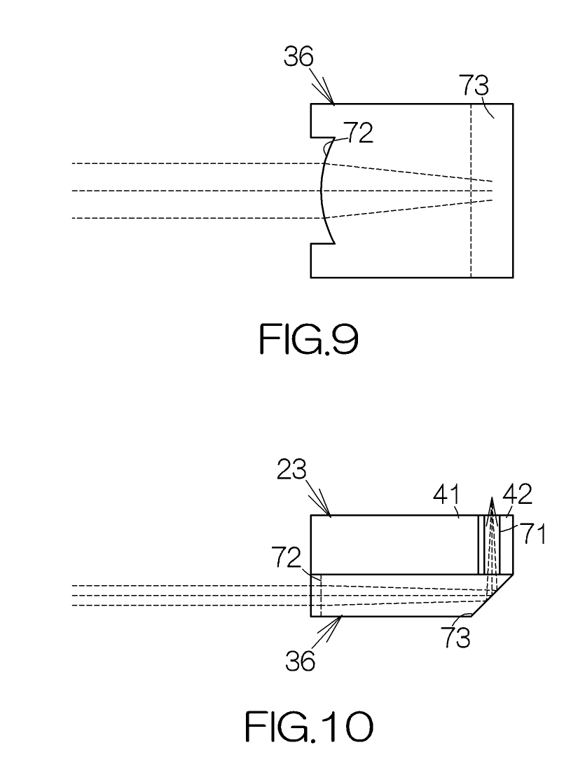

As depicted in FIG. 9, since the light-collecting surface 72 serves as an isotropic lens, a light beam is forced to converge both in the direction of the height or thickness of the coupler element 36 and in the lateral or widthwise direction of the coupler element 36. As depicted in FIG. 10, the converging light beam reflects on the light-reflective surface 73. The light-reflective surface 73 reflects the light beam at a predetermined angle of reflection. The light beam converges toward the core 71 in this manner. The light beam is introduced into the core 71 through the top surface of the coupler element 36. The light beam is then radiated onto the magnetic recording disk 14 through the air bearing surface 52. Here, a numerical aperture (NA) is set at 0.33 approximately at the top surface of the coupler element 36. The optical diameter of the light beam is set at 2 μm approximately.

Assume that magnetic bit data is to be written into the magnetic recording disk 14. The flying head slider 23 is first positioned right above a target recording track. As depicted in FIG. 11, the LD chips 27 emit light beams to the coupler elements 36, respectively. The light-collecting surface 72 of the individual coupler element 36 serves to converge the light beam. The light-reflective surface 73 reflects the light beam into the corresponding core 71. The light beam is then radiated on a magnetic recording layer, not depicted, of the magnetic recording disk 14 from the front end of the core 71. Optical energy is converted to thermal energy in the magnetic recording layer. The magnetic recording layer gets heated. The temperature of the magnetic recording layer increases. This results in decrease in the coercivity of the magnetic recording layer.

A write current is supplied to the thin film coil 68. A magnetic flux is generated in the thin film coil 68. The magnetic flux runs through the main magnetic pole 66, the auxiliary magnetic pole 67 and the connecting piece 69. The magnetic flux leaks out of the medium-opposed surface 23b. The leaked magnetic flux forms a magnetic field for recordation. Magnetic bit data is written into the magnetic recording disk 14 in this manner. When the electromagnetic transducer 43 has passed through, the temperature of the magnetic recording layer returns to a normal or room temperature. This results in an increase in the coercivity of the magnetic recording layer. The magnetic bit data can thus reliably be kept in the magnetic recording layer.

The coupler element 36 is interposed between the flying head slider 23 and the support plate 34 in the hard disk drive 11. The light-collecting surface 72 and the light-reflective surface 73 are defined on the coupler element 36. The light-collecting surface 72 collect light, the light-reflective surface 73 reflects the collected light. The light beam is in this manner directed to the core 71 of the flying head slider 23. The relative position between the coupler element 36 and the flying head slider 23 is adjusted in the process of making the head slider assembly, as described later. The flying head slider 23 and the coupler element 36 are positioned in an easier manner. The head suspension assembly 21 can be made in a relatively facilitated manner.

In addition, the LD chips 27 in a pair is supported on the single support member 26 on the carriage arm 19 in a space between the adjacent one of the magnetic recording disks 14. The carriage arm 19 is prevented from an increase in its weight to the utmost. Moreover, the support member 26 is placed in the opening 25 defined in the carriage arm 19. This results in a reduction in the thickness of the carriage arm 19 as compared with the case where the support member 26 is placed on the surface of the support member 26.

Furthermore, the single pole head 61 is placed at a position downstream of the core 71. The single pole head 61 is allowed to pass over a predetermined spot on the magnetic recording layer immediately after the light radiated from the core 71 has heated the magnetic recording layer at the predetermined spot. Magnetic bit data can be written just when the coercivity of the magnetic recording layer has decreased. The light can be utilized in an efficient manner. A magnetic field for recordation may have only a relatively small intensity for writing magnetic bit data.

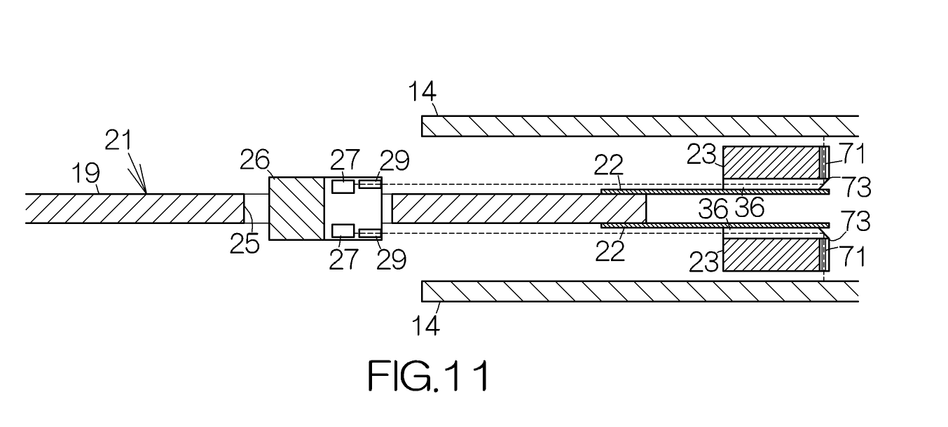

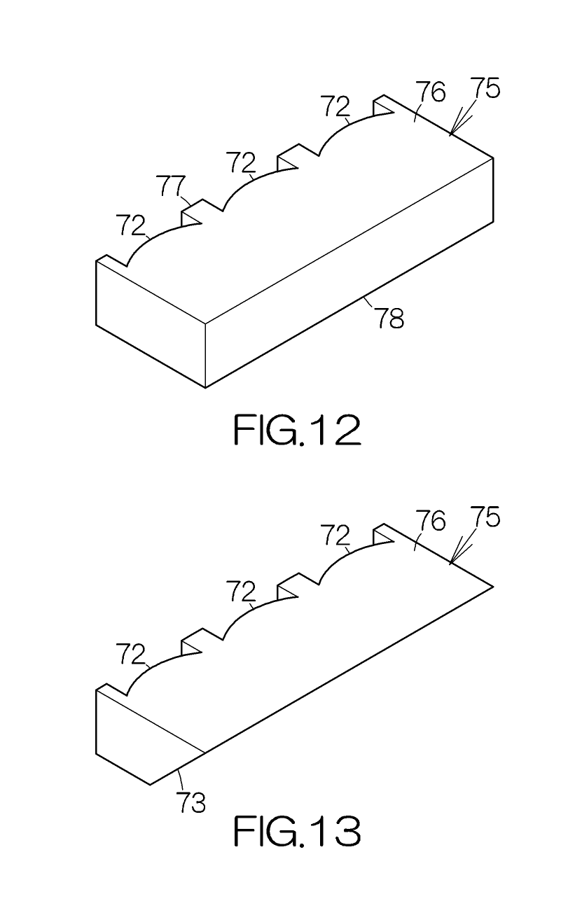

Next, a brief description will be made on a method of making a head slider assembly. As depicted in FIG. 12, a molded product 75 is first formed. The molded product 75 is elongated in the lateral direction. A die is utilized to mold the molded product 75. The molded product 75 has a thickness in a range from 2 mm to 5 mm, approximately, for example. The light-collecting surfaces 72 are formed in a row at predetermined intervals on an edge 77 of the molded product 75. The edge is defined at an end of a reference surface 76 extending in the lateral direction of the molded product 75. In this case, three of the light-collecting surfaces 72 are arranged, for example. Grinding or polishing process is applied to an edge 78 at the farside of the edge 77. As depicted in FIG. 13, the light-reflective surface 73 is thus formed. The light-reflective surface 73 intersects with the reference surface 76 at a predetermined inclination angle. The light-reflective surface 73 extends in the lateral direction. The inclination angle is set at 45 degrees, for example.

As depicted in FIG. 14, an elongated wafer bar 79 is bonded to the reference surface 76 of the molded product 75. Head sliders are defined in the wafer bar 79. The head sliders are arranged in a row at intervals identical to that of the light-collecting surfaces 72. Specifically, head sliders, three of them in this case, are defined on the wafer bar 79. The medium-opposed surface 23b has beforehand been established on the surface of the wafer bar 79. The electromagnetic transducers 43 and the cores 71 have also beforehand been embedded in the wafer bar 79. As conventionally known, the wafer bar 79 is cut out of a wafer. The read head 62, the core 71 and the single pole head 61 have beforehand been formed on the wafer. A conventional photolithographic technique is utilized for forming.

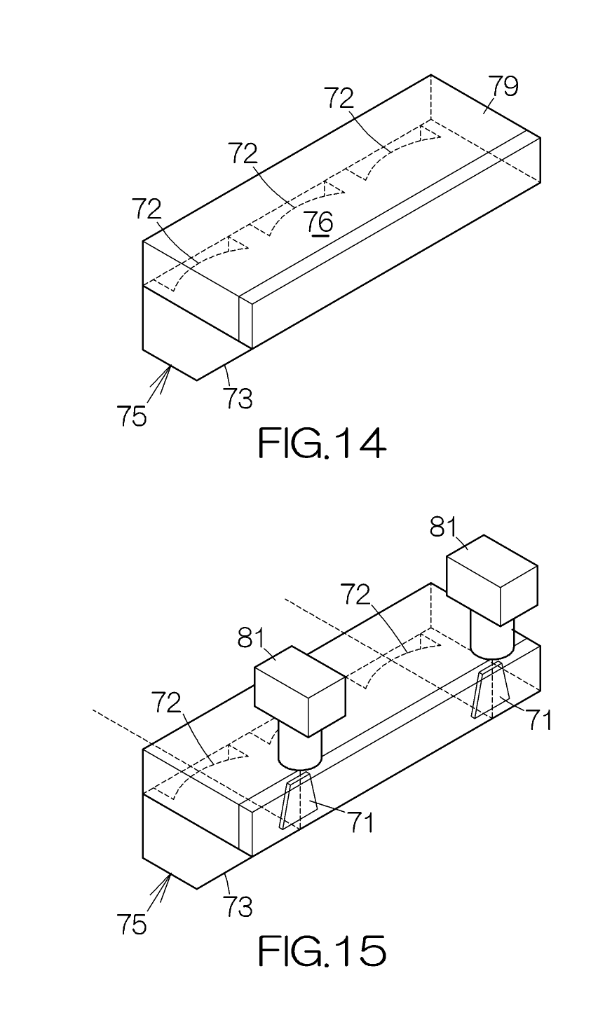

As depicted in FIG. 15, microscopes 81, two of them in this case, are set on the surface of the wafer bar 79, for example. A television camera is coupled to the microscope 81, for example. The microscopes 81 are positioned right above the cores 71 at the opposite ends of the wafer bar 79. Light beams are introduced through the light-collecting surfaces 72, respectively. The light-reflective surfaces 73 reflect the light beams, respectively. The quantity of the light beams is measured at the microscopes 81, respectively. The measured quantity of light is utilized to align the wafer bar 79 relative to the molded product 75. In this case, an ultraviolet curing adhesive is beforehand interposed between the molded product 75 and the wafer bar 79, for example. Ultraviolet rays are radiated to the molded product 75 after the wafer bar 79 has been aligned with the molded product 75. The adhesive is thus cured.

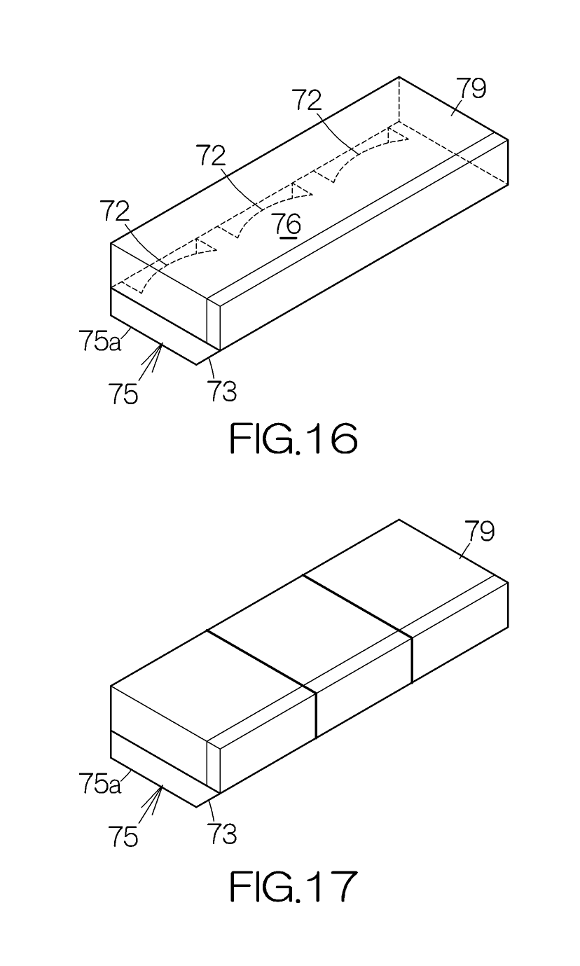

After the molded product 75 and the wafer bar 79 have been bonded to each other, the molded product 75 is subjected to grinding or polishing process on the farside of the reference surface 76. As depicted in FIG. 16, a flat surface 75a is established on the molded product 75 based on the grinding or polishing process. The flat surface 75a extends in parallel with the reference surface 76. The thickness of the molded product 75 is set at 0.23 mm approximately. As depicted in FIG. 17, the head slider assemblies are individually cut out of the composite material made of the molded product 75 and the wafer bar 79. Each of the head slider assemblies is then bonded to the support plate 34 of the flexure 32.

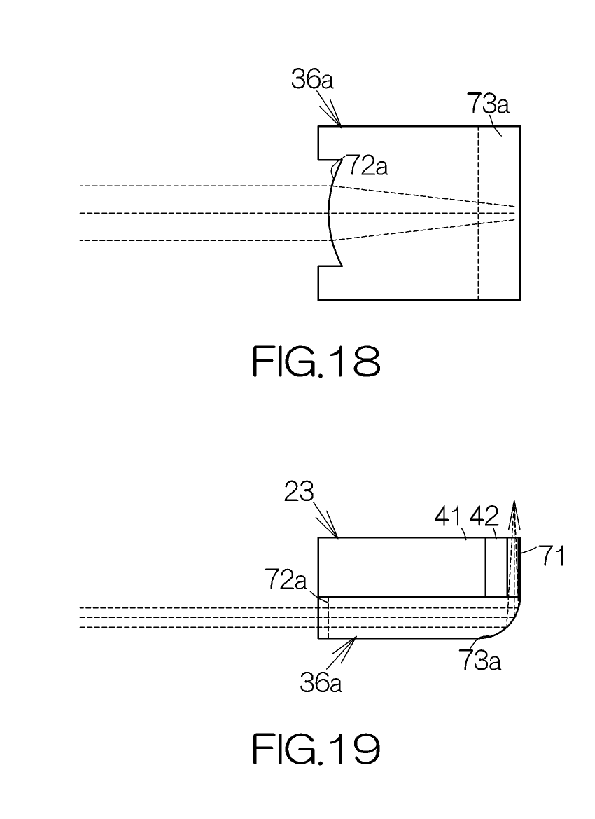

Alternatively, a coupler element 36a may be incorporated in the head suspension assembly 21 in place of the coupler element 36, as depicted in FIG. 18. The coupler element 36a has a light-collecting surface 72a made of a cylindrical surface. The longitudinal axis of the cylindrical surface extends in the direction perpendicular to the surface of the coupler element 36a. The curvature of the cylindrical surface may be set at 0.56 mm. Referring also to FIG. 19, a light-reflective surface 73a is formed as a paraboloidal surface. The light-collecting surface 72a serves to converge a light beam in the lateral or widthwise direction of the coupler element 36a. The light-reflective surface 73a reflects the converging light beam, while the light-reflective surface 73a serves to converge the light beam in the direction of the height or thickness of the coupled element 36. The light-reflective surface 73a reflects the light beam at a predetermined angle of reflection in the same manner as described above. The light beam is introduced into the core 71 through the top surface of the coupler element 36a.

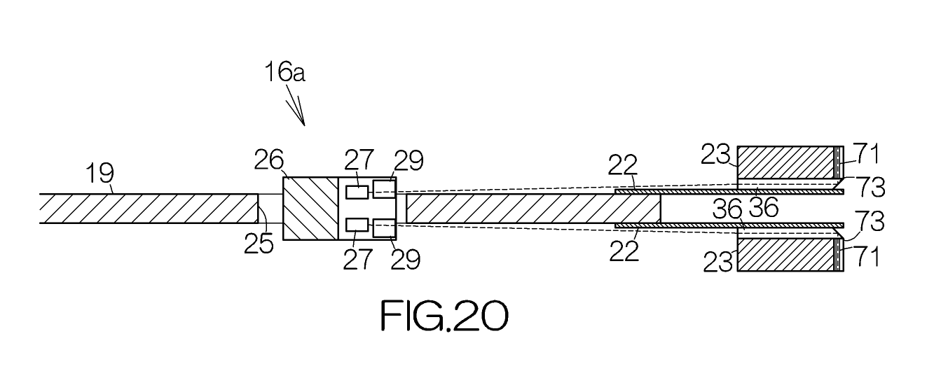

FIG. 20 schematically depicts a carriage assembly 16a according to a second embodiment. A light beam is obliquely introduced into the coupler element 36 in the carriage assembly 16a. Here, the incident angle of the light beam is set in a range between 0.2 degrees and 3.0 degrees from a horizontal plane parallel to the bottom surface of the base 13. The light beam gets farther from the surface of the carriage arm 19 as the position gets farther from the LD chip 27. Like reference numerals are attached to the structure or components equivalent to those of the aforementioned carriage assembly 16.

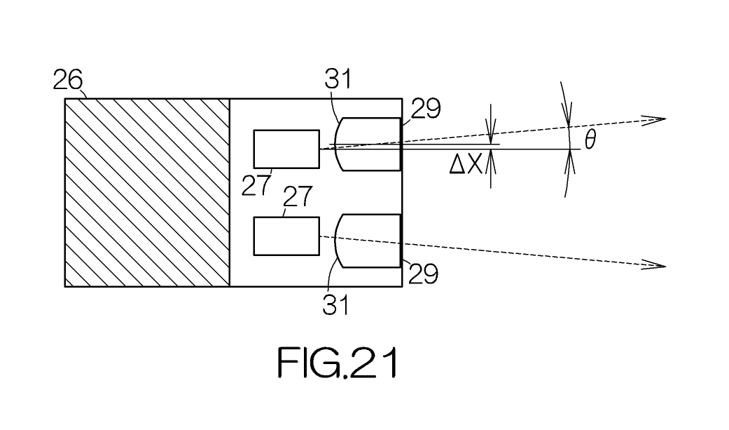

As depicted in FIG. 21, the optical axis of the LD chip 27 may be shifter from the central axis of the coupling lens 29 for adjusting the incident angle. The relationship between the incident angle θ and the shift amount ΔX between the optical axis of the LD chip 27 and the central axis of the coupling lens 29 is defined by the expression: ΔX=f×sin θ. “f” denotes a focal length of the coupling lens 29. The carriage assembly 16a enables a reliable supply of light to the coupler element 36 from the LD chip 27 even when the height of the optical axis of the LD chip 27 from the surface of the carriage arm 19 is different from the height of the coupler element 36 from the surface of the carriage arm 19.

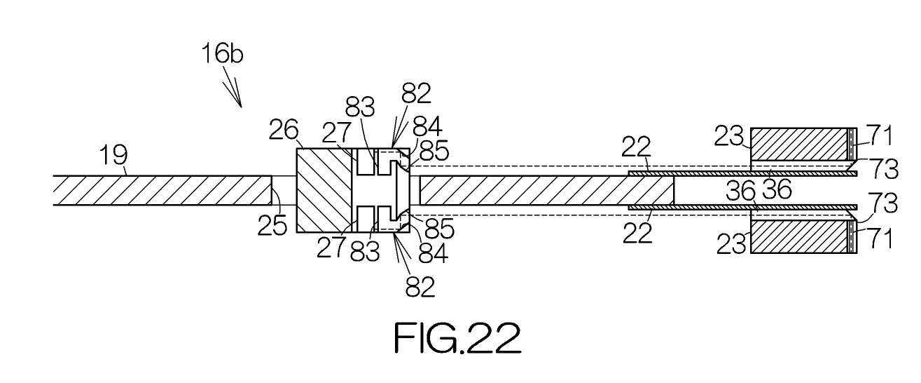

FIG. 22 schematically depicts a carriage assembly 16b according to a third embodiment. A coupler element 82 is supported on the support member 26 in place of the coupling lens 29 in the carriage assembly 16b. The coupler element 82 has a light-collecting surface 83 and a pair of light-reflective surfaces 84, 85. The light-collecting surface 83 is opposed to the front end of the LD chip 27 at a distance. The light-reflective surfaces 84, 85 direct the introduced light beam from the light-collecting surface 83 to the coupler element 36. The light-reflective surfaces 84, 85 are arranged in the vertical direction perpendicular to the bottom surface of the base 13. The light-reflective surface 84 is defined within a plane. The light-reflective surface 85 is made of a paraboloidal surface. Like reference numerals are attached to the structure or components equivalent to those of the aforementioned carriage assembly 16.

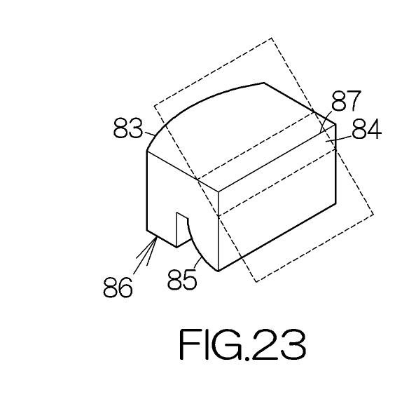

The coupler element 82 enables a reliable supply of light to the coupler element 36 from the LD chip 27 in the carriage assembly 16b even when the height of the optical axis of the LD chip 27 from the surface of the carriage arm 19 is different from the height of the coupler element 36 from the surface of the carriage arm 19. A molded product 86 is formed for making the coupler element 82, as depicted in FIG. 23. Grinding process may be applied to an edge 87 of the molded product 86.

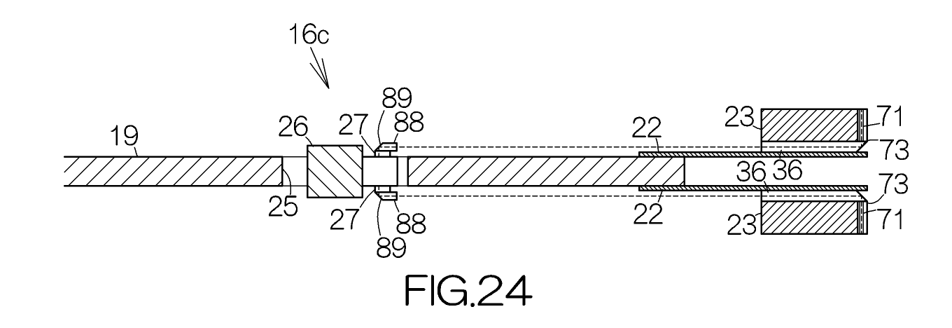

FIG. 24 schematically depicts a carriage assembly 16c according to a fourth embodiment. A surface-emitting laser chip is employed as the LD chips 27 in the carriage assembly 16c. A coupler element 88 is attached to the surface of the LD chip 27. The coupler element 88 has a light-reflective surface 89. The coupler element 88 reflects a light beam from the corresponding LD chip 27 at a predetermined angle of reflection. The light can thus reliably be supplied to the coupler element 36. Like reference numerals are attached to the structure or components equivalent to those of the aforementioned carriage assembly 16. Since surface-emission is established in the LD chips 27, the carriage arm 19 is prevented from an increase in the thickness of the carriage arm 19.

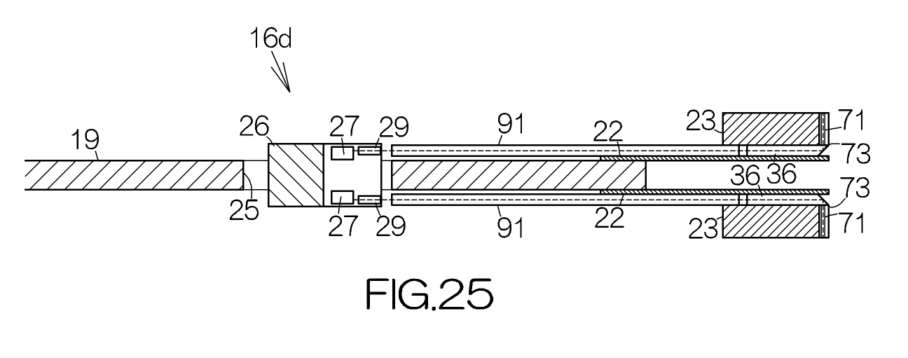

FIG. 25 schematically depicts a carriage assembly 16d according to a fifth embodiment. Optical fibers 91 are utilized to connect the coupling lenses 29 to the coupler element 36, respectively, in the carriage assembly 16d. The collected light beam is introduced into the proximal end of the optical fiber 91 from the coupling lens 29. The collected light is supplied to the coupler element 36 from the distal end of the optical fiber 91. The numerical aperture (NA) of the optical fiber 91 is set at 0.2 approximately. The optical fiber 91 has a core diameter of 4 μm approximately and a clad diameter of 125 μm approximately, for example.

As depicted in FIG. 26, a groove or notch 92 is formed in the coupler element 36 to receive the distal end of the optical fiber 91. The light-collecting surface 72 is defined on the inner end of the groove 92. The distance is set at 0.2 mm approximately between the distal end of the optical fiber 91 and the light-collecting surface 72. The curvature of the light-collecting surface 72 is set at 0.12 mm approximately. The distance is set at 0.5 mm approximately between the light-collecting surface 72 and the core 71 of the flying head slider 23, for example. A numerical aperture (NA) of 0.28 is established at the light-collecting surface 72. The optical diameter of the light beam introduced into the core 71 is set at 2.4 μm. Like reference numerals are attached to the structure or components equivalent to those of the aforementioned carriage assembly 16.

The optical fiber 91 enables a reliable supply of light from the LD chip 27 to the coupler element 36 in the carriage assembly 16d. In addition, the optical fiber 91 extends straight from the LD chip 17 to the coupler element 36. Even when a single-mode fiber is employed as the optical fiber 91, it is possible to reliably keep a plane of polarization constant. It is not required to utilize a polarization maintaining fiber as the optical fiber 91. Moreover, the employment of the optical fiber 91 allows misalignment between the LD chip 27 and the coupler element 36, for example.

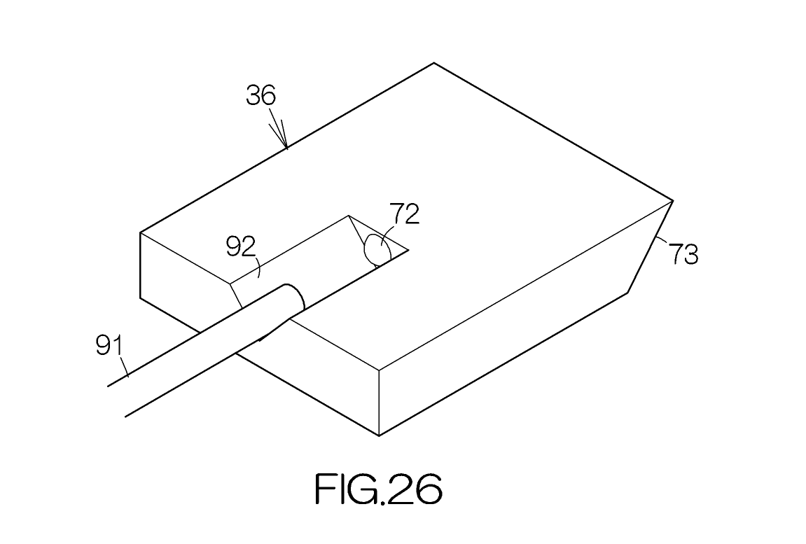

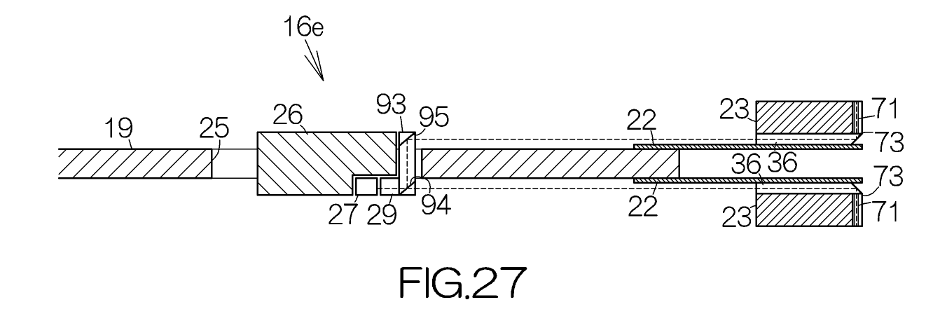

FIG. 27 schematically depicts a carriage assembly 16e according to a sixth embodiment. A single LD chip 27 and a single coupling lens 29 are supported on the support member 26 in the carriage assembly 16e. A beam splitter 93 is coupled to the coupling lens 29. The bam splitter 93 is supported on the support member 26. The coupling lens 29 enables supply of a parallel beam to the beam splitter 93. Like reference numerals are attached to the structure or components equivalent to those of the aforementioned carriage assembly 16.

A light-transmission surface 94 and a light-reflective surface 95 are defined in the beam splitter 93. The light-transmission surface 94 allows transmission of a light beam from the coupling lens 29 through the light-transmission surface 94. The light-transmission surface 94 also reflects a part of the light beam from the coupling lens 29. For example, 50% approximately of the light beam is transmitted through the light-transmission surface 94 while the remainder of the light beam is reflected, for example. The light beam transmitted through the light-transmission surface 94 is supplied to one of the coupler elements 36. The light beam reflected on the light-transmission surface 94 is reflected on the light-reflective surface 95 by a predetermined angle. The reflectance of the light-reflective surface 95 is set at almost 100%. The reflected light beam is supplied to the other of the coupler elements 36. The single LD chip 27 in this manner enables supply of light beams to two of the coupler elements 36.

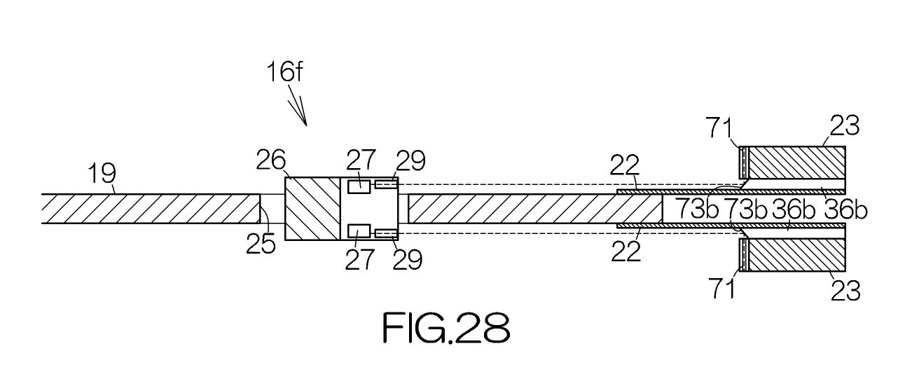

FIG. 28 schematically depicts a carriage assembly 16f according to a seventh embodiment. Coupler elements 36b are utilized in the carriage assembly 16f. The flying head slider 23 is received on the coupler element 36b in the attitude reverse to that of the aforementioned embodiments. Specifically, the inflow end is positioned closer to the front end of the carriage assembly 16f. The outflow end is positioned closer to the supported end of the carriage assembly 16f. The head protection film 42 is placed closer to the supported end of the carriage assembly 16f. The magnetic recording disk 14 is driven for rotation in the reverse direction of that of the aforementioned embodiments in the hard disk drive 11. The electromagnetic transducer 43 and the core 71 may be made in the aforementioned manner.

The coupler element 36b has a light-reflective surface 73b in its end surface opposed to the LD chip 27. The light-reflective surface 73b enables reflection of light supplied from the LD chip 27 into the air. A protection film, not depicted, may be made on the light-reflective surface 73b. The light is supplied to the core 71. Here, the light-reflective surface 73b also functions as a light-collecting surface. The light-reflective surface 73b serves to converge the light into the core 71. Like reference numerals are attached to the structure or components equivalent to those of the aforementioned carriage assembly 16. The carriage assembly 16f enables a reduction in the distance between the head protection film 42 and the LD chip 27 as compared with the case where the head protection film 42 is placed closer to the front end of the carriage assembly 16f. The light can thus be utilized with a higher efficiency.

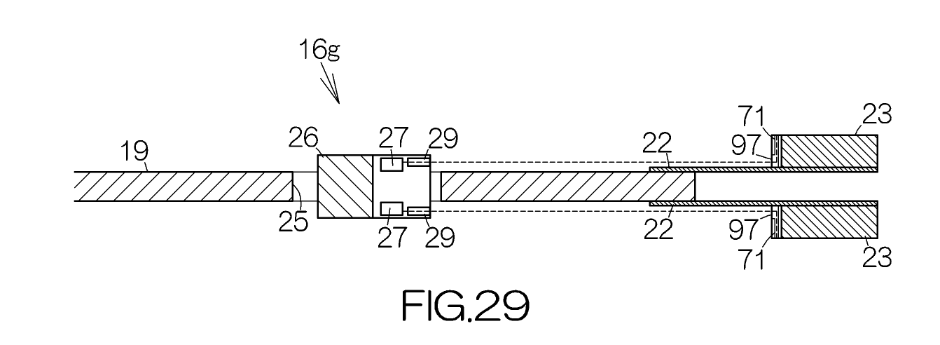

FIG. 29 schematically depicts a carriage assembly 16g according to an eighth embodiment. The coupler elements 36, 36a, 36b are omitted in the carriage assembly 16g. The flying head slider 23 is supported on the surface of the support plate 34 of the flexure 32. The inflow end of the flying head slider 23 is positioned closer to the front end of the carriage assembly 16g in the same manner as the flying head slider 23 of the carriage assembly 16f. The outflow end of the flying head slider 23 is positioned closer to the supported end of the carriage assembly 16g. The magnetic recording disk 14 is driven for rotation in the reverse direction in the hard disk drive 11.

The core 71 is partly exposed at the outflow end surface in the flying head slider 23. A grating 97 is formed in the exposed portion of the core 71. A light beam is directly supplied to the exposed portion from the LD chip 27. The grating 97 enables diffusion of the light. The light is introduced into the core 71 in this manner. Like reference numerals are attached to the structure or components equivalent to those of the aforementioned carriage assembly 16.

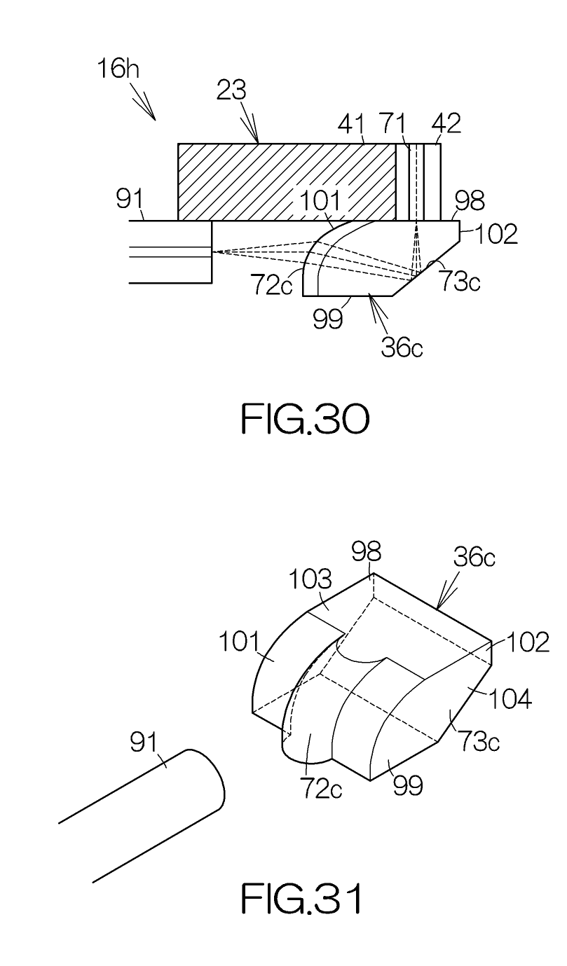

FIG. 30 schematically depicts a carriage assembly 16h according to a ninth embodiment. A coupler element 36c is utilized in the carriage assembly 16h. The coupler element 36c has a light-collecting surface 72c and a light-reflective surface 73c. The light-collecting surface 72c is opposed to the distal end of the optical fiber 91 at a distance. The proximal end of the optical fiber 91 is opposed to the LD chip 27 at a distance. The optical fiber 91 serves to emit an expanding light beam to the light-collecting surface 72c. The light-collecting surface 72c collects the light. The collected light is then reflected on the light-reflective surface 73c at a predetermined angle of reflection. The light is in this manner directed to the core 71. Here, the distance is set at 0.3 mm approximately between the distal end of the optical fiber 91 and the light-collecting surface 72c. The distance is set at 0.3 mm approximately between the light-collecting surface 72c and the focal point of the light-collecting surface 72c. Like reference numerals are attached to the structure or components equivalent to those of the aforementioned embodiment.

The coupler element 36c has a first flat surface 98 and a second flat surface 99. The first flat surface 98 is configured to receive the supported surface 23a of the flying head slider 23. The second flat surface 99 extends in parallel with the first flat surface 98. The coupler element 36c is received on the support plate 34 at the second flat surface 99. A first side surface 101 and a second side surface 102 connect the first flat surface 98 to the second flat surface 99. The first side surface 101 includes the light-collecting surface 72a. The second side surface 102 includes the light-reflective surface 73c. The first side surface 101 is opposed to the second side surface 102. As depicted in FIG. 31, a third side surface 103 and a fourth side surface 104 connect the first flat surface 98 to the second flat surface 99. The third side surface 103 extends in parallel with the fourth side surface 104. Here, the light-collecting surface 72c is made of a curved surface, namely an anomorphic aspheric surface. The light-reflective surface 73c is a flat surface.

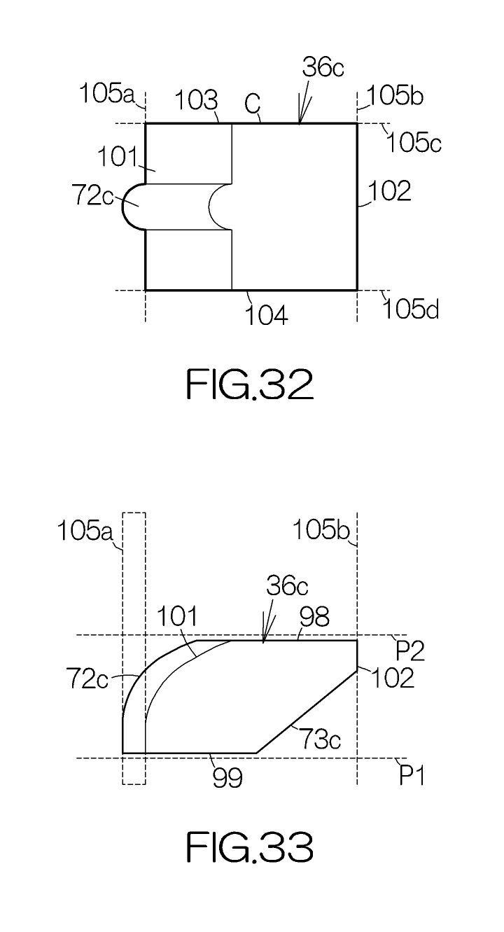

As depicted in FIG. 32, a plan view of the coupler element 36c defines the contour C of the coupler element 36c. First, second, third and fourth imaginary wall surfaces 105a, 105b, 105c, 105d perpendicularly stand upright from the contour C of the coupler element 36c. The first imaginary wall surface 105a includes planes set parallel to the second imaginary wall surface 105b made of a plane. The third imaginary wall surface 105c made of a plane is set parallel to the fourth imaginary wall surface 105d made of a plane. The third side surface 103 of the coupler element 36c extends within the third imaginary wall surface 105c. The fourth side surface 104 extends within the fourth imaginary wall surface 105d. The first side surface 101, namely the light-collecting surface 72c, gets farther from the first imaginary wall surface 105a as the position gets farther from a first reference plane P1 including the second flat surface 99, as depicted in FIG. 33. The second side surface 102 extends partially within the second imaginary wall surface 105b from an edge on the boundary of the first flat surface 98. The second side surface 102, namely the light-reflective surface 73c, gets farther from the second imaginary wall surface 105b as the position gets farther from a second reference plane P2 including the first flat surface 98.

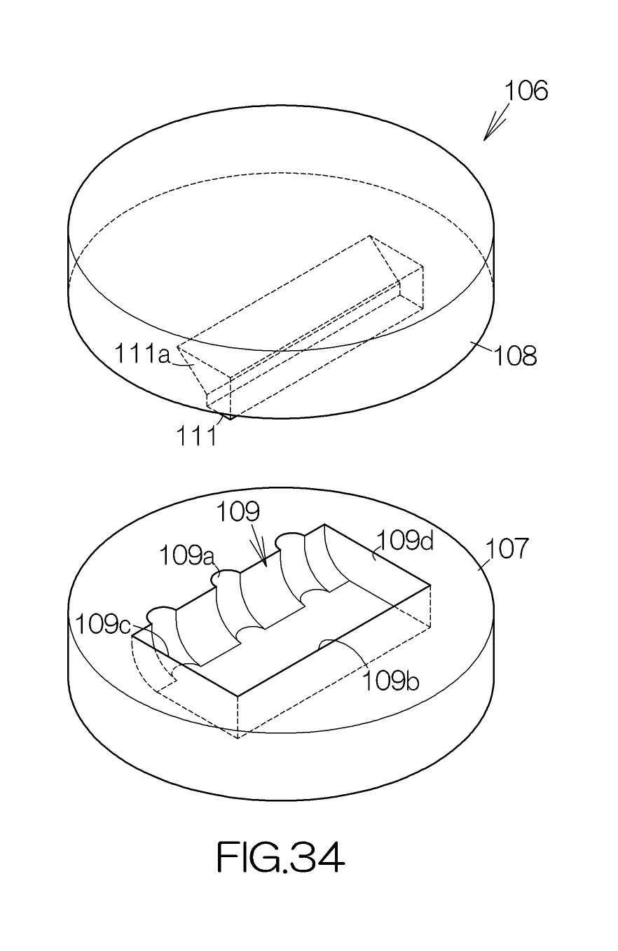

Next, description will be made on a method of making the coupler element 36c. FIG. 34 depicts the structure of a die 106 utilized to mold the coupler element 36c. The die 106 includes a disk-shaped lower die 107 and a disk-shaped upper die 108 set on the front surface of the lower die 107, for example. The central axis of the lower die 107 coincides with that of the upper die 108. A cavity 109 is defined in the lower die 107. The cavity 109 is shaped to have a shape of continuous coupler elements 36c arranged in the lateral direction, for example. The upper die 108 defines a protrusion 111 protruding from the back or lower surface of the upper die 108. When the back surface of the upper die 108 is set on the front surface of the lower die 107, the protrusion 111 is received in the cavity 109. The cavity 109 is thus closed.

The cavity 109 of the lower die 107 defines an opposed pair of a first side wall 109a and a second side wall 109b and an opposed pair of a third side wall 109c and a fourth side wall 109d. The first side wall 109a defines the first side surface 101 of the coupler element 36c. Likewise, the third side wall 109c defines the third side surface 103. The fourth side wall 109d defines the fourth side surface 104. The bottom surface of the cavity 109 defines the first flat surface 98. Referring also to FIG. 35, the protrusion 111 of the upper die 108 has a side surface 111a. The side surface 111a defines the second side surface 102 of the coupler element 36c. When the back surface of the upper die 108 is superposed on the front surface of the lower die 107, the cavity 109 defines the shape of the coupler element 36c. The back surface of the upper die 108 defines the second flat surface 99 outside the protrusion 111.

A preform is placed in the cavity 109 to mold the coupler element 36c. The perform is made of a glass material, for example. The glass material is heated. The glass material is thus softened. The lower die 107 and the upper die 108 approach each other along their central axes. The back surface of the upper die 108 is thus superposed on the front surface of the lower die 107. The lower die 107 and the upper die 108 are urged against each other with a predetermined urging force. The glass material uniformly spreads inside the cavity 109. The glass material is then cooled. The glass material is thus hardened or cured. In this manner, the glass material is molded in a predetermined shape. The molded product is taken out of the cavity 109. The coupler elements 36c are then separately cut out of the molded product. The individual coupler elements 36c are in this manner produced.

The first side surface 101 and the second side surface 102 of the coupler element 36c get farther from the first imaginary wall surface 105a and the second imaginary wall surface 105b as the positions get farther from the first reference plane P1 and the second reference plane E2, respectively. The third side surface 103 and the fourth side surface 104 are defined along the third imaginary wall surface 105c and the fourth imaginary wall surface 105d, respectively. Since the first to fourth imaginary wall surfaces 105a-105d perpendicularly stand upright from the contour C, the molded product, namely the coupler elements 36c, can be taken out of the die 106 in a relatively facilitated manner. Only two dies, namely the lower die 107 and the upper die 108, are utilized to mold the coupler elements 36c in a relatively facilitated manner. The coupler elements 36c can be mass-produced at a time.

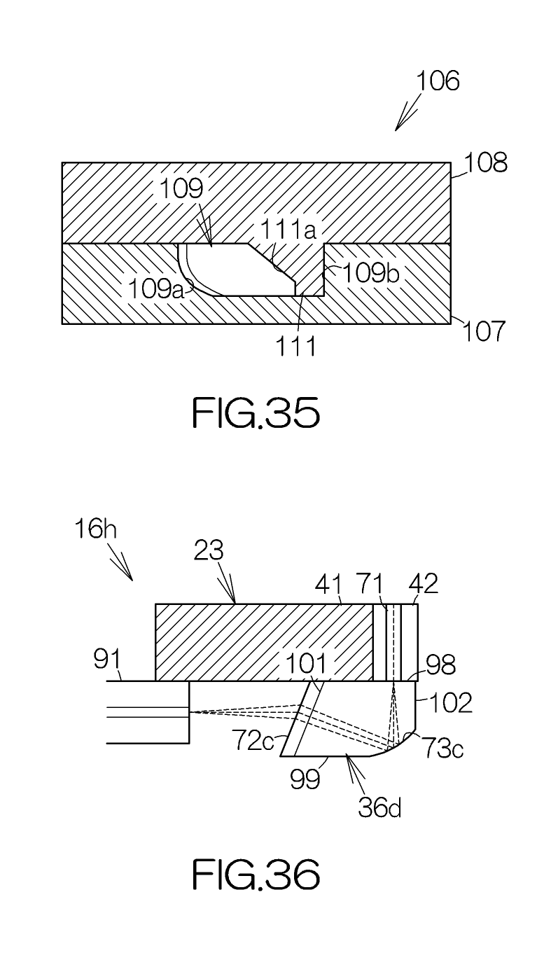

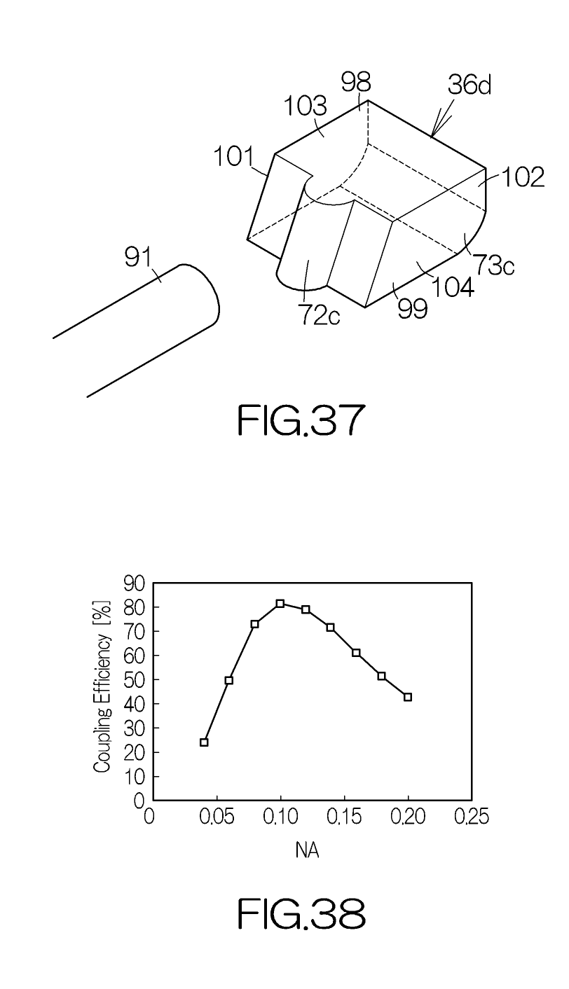

As depicted in FIG. 36, a coupler element 36d may be incorporated in the carriage assembly 16h in place of the aforementioned coupler element 36c. As depicted in FIG. 37, the light-collecting surface 72c is a partial cylindrical surface in the coupler element 36d. The generatrices of the cylindrical surface intersects with the first flat surface 98 by a predetermined inclination angle, for example. The light-reflective surface 73c is a partial cylindrical surface. The generatrices of the partial cylindrical surface of the light-reflective surface 73c extends in parallel with the first flat surface 98 in the lateral direction. The light-reflective surface 73c thus functions as a light-collecting surface. Like reference numerals are attached to the structure or components equivalent to those of the aforementioned coupler element 36c.

The coupler element 36d is made in the same manner as the aforementioned coupler element 36c. The coupler elements 36d can thus be mass-produced at a time. Since the light-collecting surface 72c is a collection of the aforementioned parallel generatrices, a grinding tool may only be subjected to parallel movement to grind a die utilized for making the coupler elements 36c. A complex three-dimensional process including a directional control of the grinding tool is not necessary. The die can thus be produced in a relatively facilitated manner.

The light-reflective surface 73c also functions as a light-collecting surface. In the case where the distance is relatively short between the supported surface 23a and the light-reflective surface 73c, the collection of light over a wide range makes the numerical aperture (NA) increase. The increase in the numeric aperture results in a deterioration in the coupling efficiency. FIG. 38 depicts the relationship between the numerical aperture and the coupling efficiency for a single-mode optical fiber. As is apparent from the graph of FIG. 38, when the numerical aperture is set at 0.10, the coupling efficiency is maximized. Accordingly, the coupler element 36d may be designed to achieve the optimal numerical aperture. In addition, the distance is set relatively long between the supported surface 23a of the flying head slider 23 and the light-reflective surface 73c in the coupler element 36d. The light-reflective surface 73c is thus allowed to collect light over a wider range without changing the optimal numerical aperture. The light is efficiently utilized.

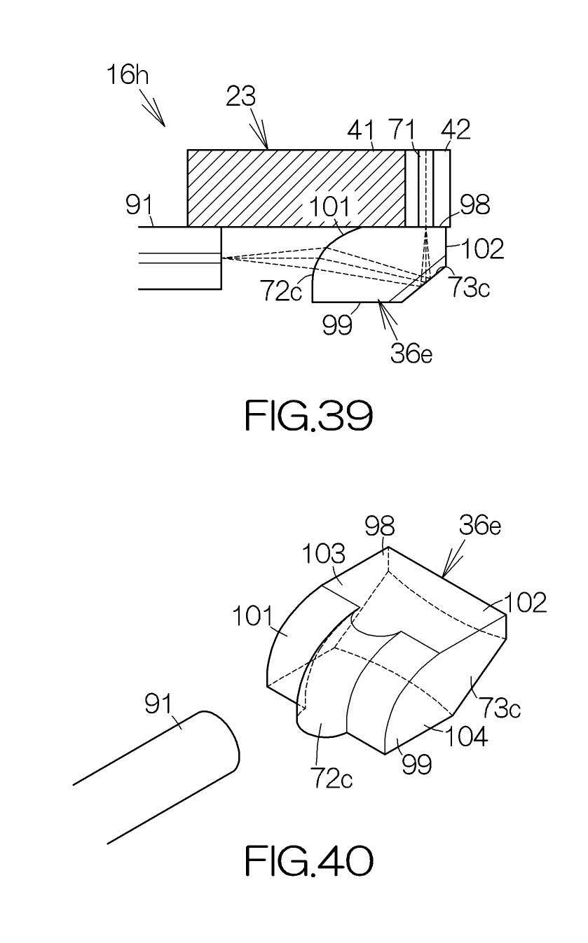

As depicted in FIG. 39, a coupler element 36e may be incorporated in the carriage assembly 16h in place of any one of the aforementioned coupler elements 36c, 36d. The first side surface 101 is a partial cylindrical surface in the coupler element 36e. The generatrices of the partial cylindrical surface of the first side surface 101 extend in parallel with the first flat surface 98 in the lateral direction. The light-reflective surface 73c is likewise a partial cylindrical surface. As is apparent from FIG. 40, the generatrices of the cylindrical surface of the light-reflective surface 73c intersect with the second flat surface 99 by a predetermined inclination angle, for example. The light-reflective surface 73c thus functions as a light-collecting surface. Like reference numerals are attached to the structure or components equivalent to those of the aforementioned coupler elements 36c, 36d.

The coupler element 36e is made in the same manner as the aforementioned coupler element 36c. The coupler elements 36e can thus be mass-produced at a time. Since the first side surface 101 is a collection of the aforementioned parallel generatices, the die can be produced in a relatively facilitated manner. In addition, the distance is set relatively long between the supported surface 23a of the flying head slider 23 and the light-reflective surface 73c in the coupler element 36e. The light-reflective surface 73c is thus allowed to collect light over a wider range without changing the optimal numerical aperture. The light is efficiently utilized.

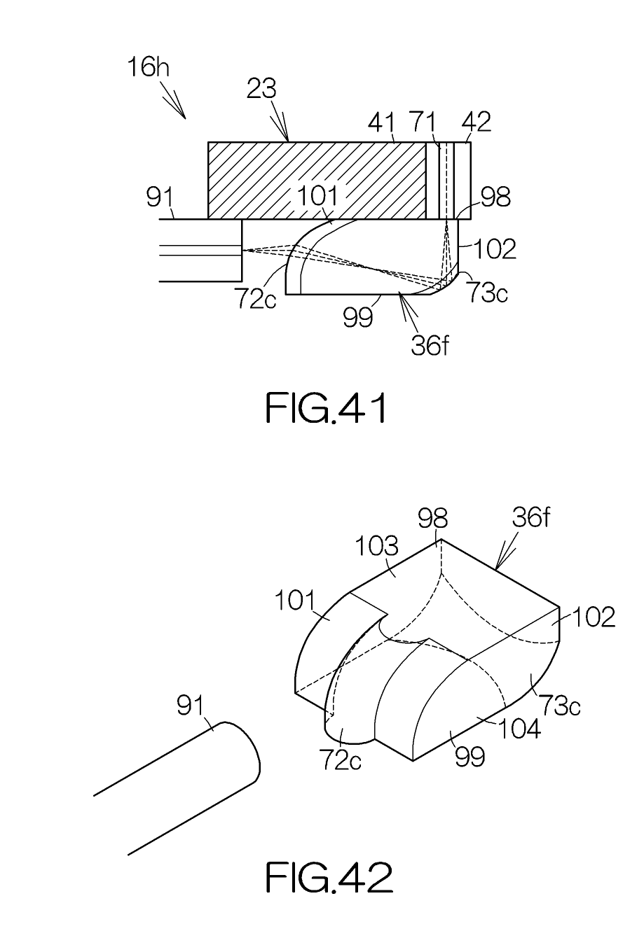

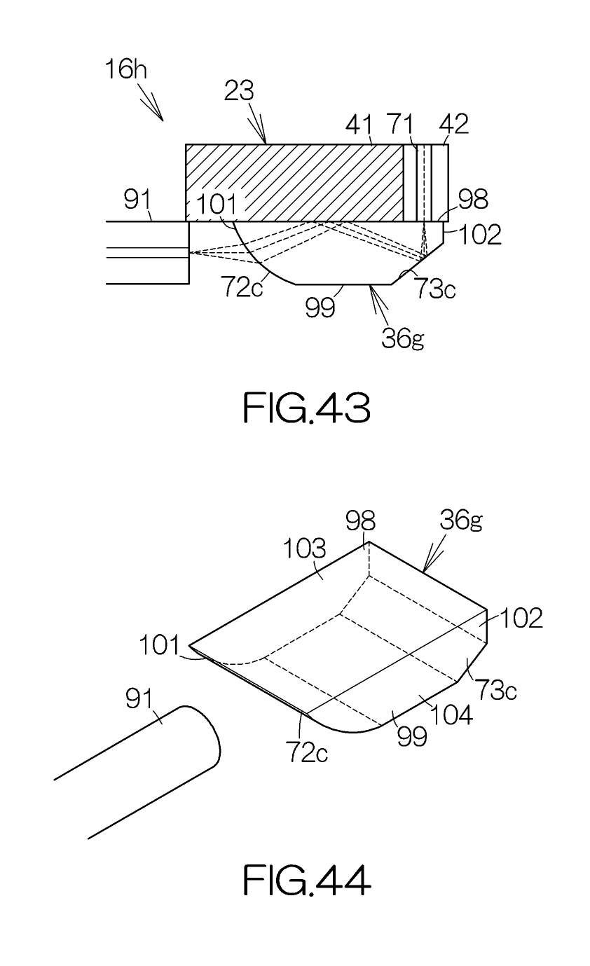

As depicted in FIG. 41, a coupler element 36f may be incorporated in the carriage assembly 16h in place of any one of the coupler elements 36c-36e. The coupler element 36f has the light-collecting surface 72c made of an anomorphic aspheric surface in the same manner as in the aforementioned coupler element 36c. As depicted in FIG. 42, the light-reflective surface 73c may be a rotational symmetry aspheric surface such as an ellipsoid, for example. The light-reflective surface 73c thus functions as a light-collecting surface. Otherwise, the light-reflective surface 73c may be a hyperboloid.

The coupler element 36f realizes a larger distance between the light-collecting surface 72c and the light-reflective surface 73c as compared with in the aforementioned ones. The length of an optical path increases as compared with in the aforementioned ones. The light is focused between the light-collecting surface 72c and the light-reflective surface 73c. The distance between the focal point and the light-collecting surface 72c is set equal to the distance between the focal point and the light-reflective surface 73c. The numerical aperture of the light entering the core 71 is set equal to that of the light input into the light-collecting surface 72c. Like reference numerals are attached to the structure or components equivalent to those of the aforementioned coupler elements 36c-36e.

The coupler element 36f is made in the same manner as the aforementioned coupler element 36c. The coupler elements 36f can thus be mass-produced at a time. Since the meridians of the light-collecting surface 72c are set to have a common curvature, the die can be produced in a relatively facilitated manner. In addition, the distance may be set relatively long between the supported surface 23a of the flying head slider 23 and the light-reflective surface 73c in the coupler element 36f. The light-reflective surface 73c is thus allowed to collect light over a wider range without changing the optimal numerical aperture. The light is efficiently utilized. Moreover, an increase in the distance of the light-collecting surface 72c and the light-reflective surface 73c is accompanied with an increase in the area of the first flat surface 98. The bonding strength is thus improved between the coupler element 36f and the flying head slider 23.

As depicted in FIG. 43, a coupler element 36g may be incorporated in the carriage assembly 16h in place of any one of the coupler elements 36c-36f. The light-collecting surface 72c is made of a partial cylindrical surface in the coupler element 36g. The generatrices of the partial cylindrical surface extend in parallel with the first flat surface 98. Here, the light-collecting surface 72c gets farther from the first imaginary wall surface 105a as the position gets farther from the aforementioned second reference plane P2. The light-reflective surface 73c may be a flat surface.

The coupler element 36g realizes a relatively larger distance between the light-collecting surface 72c and the light-reflective surface 73c in the same manner as in the aforementioned coupler element 36f. The light input through the light-collecting surface 72c is thus reflected on the first flat surface 98. Specifically, the first flat surface 98 functions as a second light-reflective surface. The reflected light is directed to the light-reflective surface 73c. Like reference numerals are attached to the structure or component equivalent to those of the aforementioned coupler elements 36c-36f.

A die 113 is utilized to make the coupler element 36g, as depicted in FIG. 45, for example. The die 113 includes a lower die 114 and an upper die 115. A cavity 116 is defined in the lower die 114. When the back surface of the upper die 115 is superposed on the front surface of the lower die 114, the cavity 116 is closed. As is apparent from FIG. 45, both the light-collecting surface 72c and the light-reflective surface 73c of the couple element 36g are defined in the cavity 116 in the lower die 114. Compared with the case where the light-reflective surface 73c is defined in the back surface of the upper die 115, for example, the light-collecting surface 72c and the light-reflective surface 73c are formed with a higher accuracy.

The coupler elements 36g can be mass-produced at a time in the same manner as described above. Since the light-collecting surface 72c is a collection of the aforementioned parallel generatrices, the die 113 can be produced in a relatively facilitated manner. In addition, an increase in the distance between the light-collecting surface 72c and the light-reflective surface 73c is accompanied with an increase in the area of the first flat surface 98. The bonding strength between the coupler element 36g and the flying head slider 23 is thus improved.

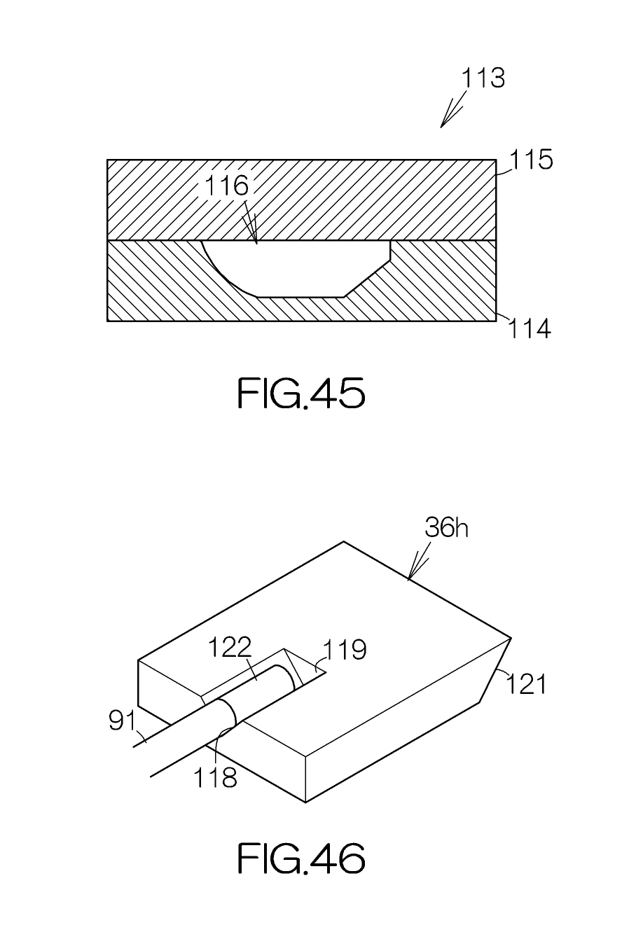

As depicted in FIG. 46, a coupler element 36h may be incorporated in the carriage assembly 16h in place of any one of the aforementioned coupler elements 36c-36g. A groove or notch 118 is formed in the coupler element 36h to receive the distal end of the optical fiber 91. A light-input surface 119 is defined in the groove 118 at the inner end of the groove 118. The light-input surface 119 is a flat surface. The light-input surface 119 is opposed to the distal end of the optical fiber 91. A light-reflective surface 121 is formed on the coupler element 36h. The light-reflective surface 121 is made of a flat surface. The light-reflective surface 121 is opposed to the light-input surface 119.

A columnar gradient index lens 122 is placed between the distal end of the optical fiber 91 and the light-input surface 119, for example. The gradient index lens 122 is bonded to the distal end of the optical fiber 91. The refractive index of the gradient index lens 122 gets smaller as the position gets farther in the centrifugal direction from its center axis. As depicted in FIG. 47, light beam is emitted from the distal end of the optical fiber 91. The light beam input into the gradient index lens 122. The gradient index lens 122 serves to converge the light beam. The converging light beam is introduced into the coupler element 36h through the light-input surface 119. The light-reflective surface 121 reflects the introduced light by a predetermined angle of reflection. The light is in this manner directed to the core 71. Like reference numerals are attached to the structure or components equivalent to those of the aforementioned coupler element 36c-36g.

The coupler element 36h is simply configured to have the light-input surface 119 and the light-reflective surface 121 both made of a flat surface. Accordingly, dicing process is employed to form the coupler element 36h. Grinding process is applied to a molded product cut out based on the dicing process. The light-input surface 119 and the light-reflective surface 121 are in this manner formed. The coupler elements 36h can be mass-produced at a time.

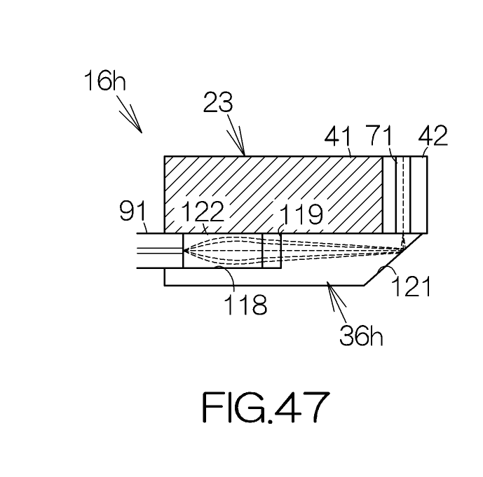

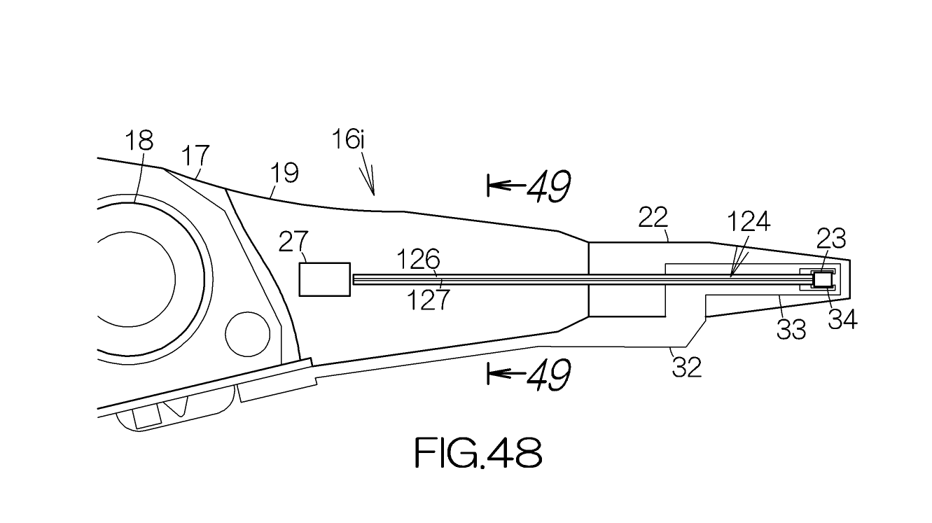

FIG. 48 schematically depicts a carriage assembly 16i according to a tenth embodiment. The carriage assembly 16i includes the LD chips 27 attached to the carriage arm 19. The LD chip 27 emits a light beam toward the tip end of the carriage arm 19. A light waveguide 124 is placed between the LD chip 27 and the corresponding flying head slider 23. The light waveguide 124 is formed on the carriage arm 19 and the head suspension 22. Here, the light waveguide 124 extends straight from the LD chip 27 to the corresponding flying head slider 23. The light waveguide 124 continuously extends on the fixation plate 33 and the support plate 34 of the flexure 32 at a position upstream of the flying head slider 23.

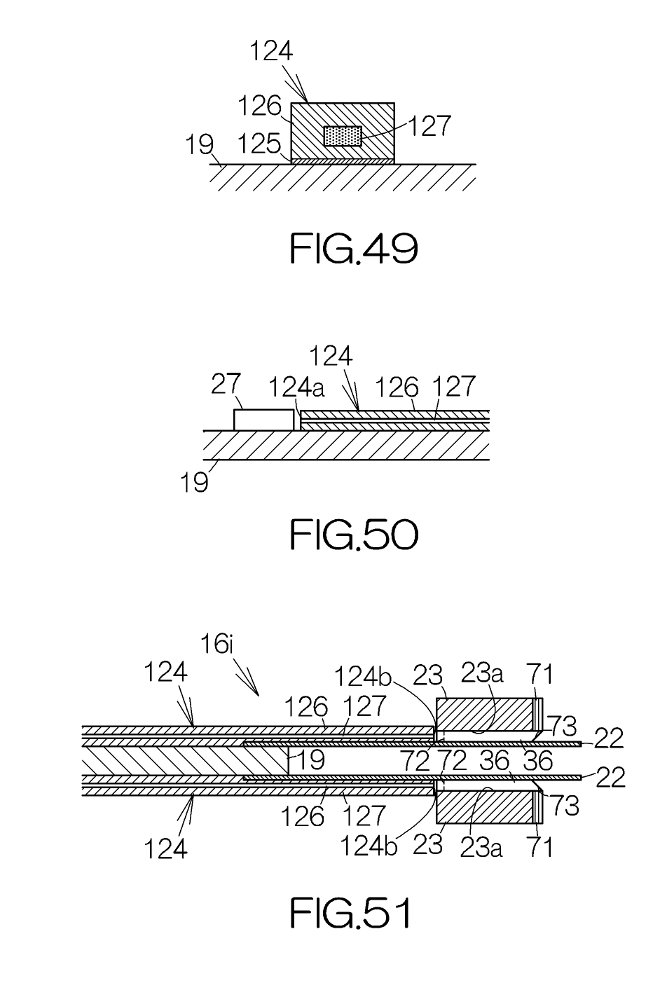

As depicted in FIG. 49, the light waveguide 124 includes a support plate 125 made of a polyimide resin, for example. A sheet clad 126 is formed on the support plate 125. A core 127 is embedded within the sheet clad 126. The sheet clad 126 and the core 127 are made of an ultraviolet curing resin material such as photopolymer, for example. Here, a difference may be provided between the refractive index of the sheet clad 126 and that of the core 127. The plane of polarization is set in a predetermined direction in the core 127. An electrically-conductive pattern, not depicted, may be placed on the light waveguide 124 on the flexure 32. Alternatively, the light waveguide 124 may be placed on the electrically-conductive pattern. The electrically-conductive pattern may be formed integral with the light waveguide 124.

As depicted in FIG. 50, one end of the light waveguide 124, namely a light-input surface 124a, is opposed to the front side of the LD chip 27. Here, the LD chip 27 may have the structure of a Febry-Perot type, for example. The LD chip 27 emits a light beam toward the light-input surface 124a. As depicted in FIG. 51, the aforementioned coupler element 36 is interposed between the supported surface 23a of the flying head slider 23 and the support plate 34. The light-collecting surface 72 of the coupler element 36 is opposed to the other end of the light waveguide 124, namely a light-output surface 124b. Like reference numerals are attached to the structure or components equivalent to those of the aforementioned embodiments.

The carriage assembly 16i includes the core 127 of the light waveguide 124 receiving a light beam emitted from the LD chip 27. The light beam is input into the core 127 through the light-input surface 124a. The light is transmitted in the core 127. The light beam is output from the light-output surface 124b of the core 127. The output light beam is directed to the coupler element 36. The light beam is in this manner directed to the core 71 of the flying head slider 23. It should be noted that the light waveguide 124 may be attached to the carriage arm 19 and the head suspension 22 for making the carriage assembly 16i. In this case, the light waveguide may previously made prior to the attachment. The carriage assembly 16i is allowed to enjoy the advantages identical to those obtained in the aforementioned embodiments.

The carriage assembly 16i utilizes the light waveguide 124, already made, attached to the carriage arm 19 and the head suspension 22. The plane of polarization is set in a predetermined direction in the light waveguide 124. The light waveguide 124 can thus be positioned on the carriage arm 19 and the head suspension 22 in a relatively facilitated manner. A troublesome operation such as alignment of the plane of polarization is not required. The carriage assemblies 16i can thus be mass-produced in a relatively facilitated manner. The production cost for the carriage assemblies 16i can be suppressed.

Alternatively, the light waveguide 124 may directly be formed on the carriage arm 19 and the head suspension 22. An ultraviolet curing resin material is applied to the carriage assembly 19 and the head suspension based on a spin coating technique for the formation of the light waveguide 124, for example. Subsequently, the sheet clad 126 and the core 127 may be formed based on the irradiation of ultraviolet rays.

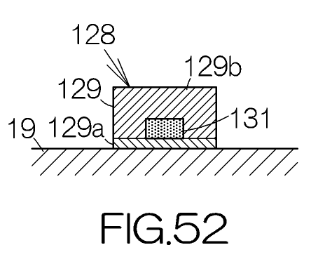

As depicted in FIG. 52, a light waveguide 128 may be incorporated in the carriage assembly 16i in place of the light waveguide 124. The light waveguide 128 includes a clad 129 and a core 131 both made of a glass material. The clad 129 includes a support layer 129a and an overcoat layer 129b covering over the core 131 on the surface of the support layer 129a. The support layer 129a of the light waveguide 128 is bonded to the carriage arm 19 and the head suspension 22. The support layer 129a is made of a borosilicate glass, for example. The support layer 129a may have a thickness in a range from 30 μm to 50 μm approximately, for example. The borosilicate glass has the refractive index of 1.473. The overcoat layer may be made of BK7, for example. The BK7 has a thickness of 0.02 mm approximately, for example. The BK7 has the refractive index of 1.53.

The core 131 is covered with the support layer 129a and the overcoat layer 129b, that is, is embedded in the clad 129. The core 131 may be made of silica glass (BPSG), for example. The core 131 has the thickness of 5 μm approximately, for example. The silica glass has the refractive index of 2.0. The light waveguide 128 made of a glass material has an improved permeability to a light beam having a wavelength of 400 nm, for example. In addition, since the glass material exhibits heat-resistance up to a relatively high temperature range, the carriage assembly 16i allows the utilization of a light beam with a high energy.

A sheet of a borosilicate glass is first prepared for the formation of the light waveguide 128. The sheet forms the support layer 129a. A silica glass layer is formed on the surface of the support layer 129a based on plasma enhanced chemical vapor deposition (PECVD), for example. Etching is effected on the silica glass layer. A Cr mask is utilized in the etching, for example. The core 131 is in this manner shaped out of the silica glass on the surface of the support layer 129a. A radio frequency (RF) sputtering technique is then effected to form the overcoat layer 129b made of BK7 on the surface of the support layer 129a. A laser process is then applied to shape the contour of the light waveguide 128, for example. It should be noted that the light waveguide 128 may alternatively be formed directly on the carriage arm 19 and the head suspension 22.

FIG. 53 schematically depicts a carriage assembly 16j according to an eleventh embodiment. The carriage assembly 16j may include the aforementioned light waveguide 124 bent to extend toward the outflow end of the flying head slider 23. Light-reflective surfaces 133, 134 are defined on the core 127 in the bent area of the light waveguide 124. The light-reflective surfaces 133, 134 are made of flat surfaces, respectively, for example. The light-reflective surfaces 133, 134 intersect with the surface of the flexure 32 at right angles. When a light beam is input into the core 127 of the light waveguide 124 from the LD chip 27, the light beam is subjected to the total internal reflection on the light-reflective surfaces 133, 134. The light beam is in this manner directed to the light-output surface 124b of the light waveguide 124. It should be noted that the light waveguide 128 may be employed in place of the light waveguide 124.

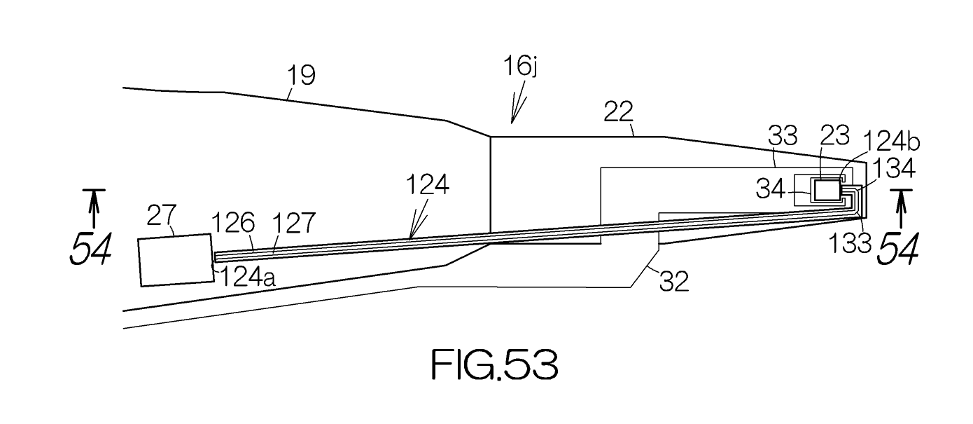

As depicted in FIG. 54, the aforementioned coupler element 36b is interposed between the supported surface 23a of the flying head slider 23 and the support plate 34. The light-output surface 124b of the light waveguide 124 is opposed to the light-reflective surface 73b of the coupler element 36b. The light-reflective surface 73b is made of a partial cylindrical surface, for example. The light-reflective surface 73b also functions as a light-collecting surface as described above. The light-reflective surface 73b is opposed to the core 71 of the flying head slider 23. Light output from the light-output surface 124b of the light waveguide 124 is thus directed to the core 71 of the flying head slider 23. Like reference numerals are attached to the structure or components equivalent to those of the aforementioned embodiments. The carriage assembly 16j is allowed to enjoy the advantages identical to those obtained in the aforementioned embodiments.

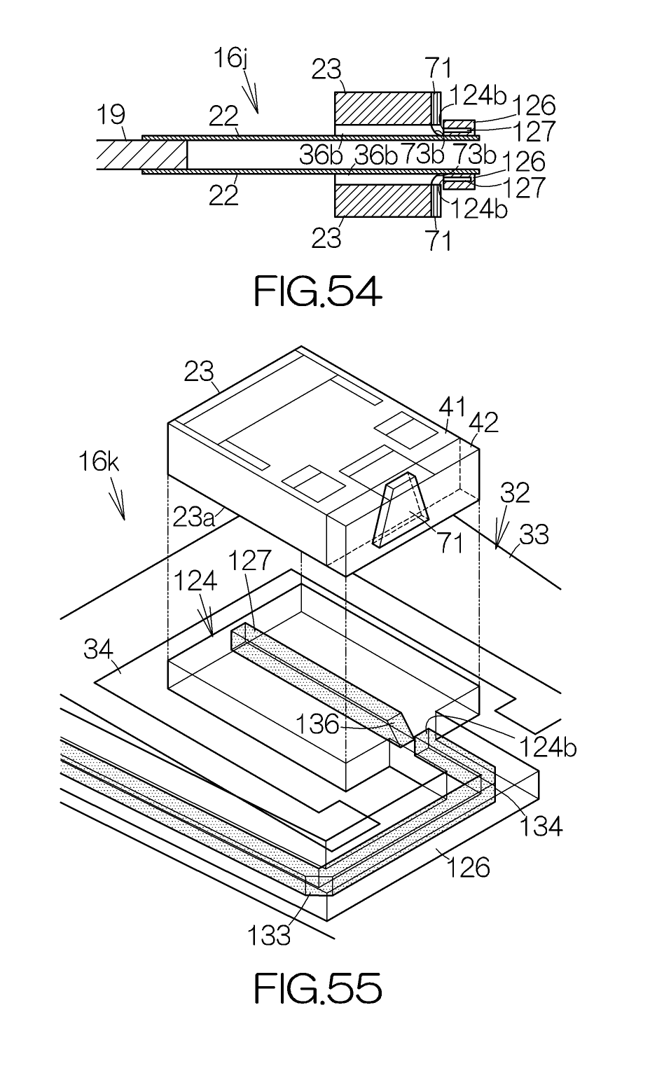

FIG. 55 schematically depicts a carriage assembly 16k according to a twelfth embodiment. The carriage assembly 16k includes the light waveguide 124 reaching the supported surface 23a of the flying head slider 23. The other end of the light waveguide 124 is interposed between the supported surface 23a and the support plate 34. The other end of the light waveguide 124 extends between the supported surface 23a and the support plate 34 by a constant thickness. Here, the other end of the light waveguide 124 may have the contour identical to that of the flying head slider 23. The core 127 of the light waveguide 124 extends between the supported surface 23a and the support plate 34.

Referring also to FIG. 56, an opening 135 is defined in the sheet clad 126. The core 127 is divided into two in the opening 135. One of the divided portions of the core 127 has an end surface defining the light-output surface 124b. The other divided portion of the core 127 has an end surface defining a light-reflective surface 136. The light-reflective surface 136 is opposed to the light-output surface 124b at a distance. The light-reflective surface 136 may be made of an inclined surface intersecting with the surface of the support plate 34 by a predetermined inclination angle of 45 degrees, for example. A light beam is transmitted through the core 127. The light beam is then output from the light-output surface 124b of the light waveguide 124. The light-reflective surface 136 reflects the light beam. The reflected light is input into the core 71. Like reference numerals are attached to the structure or components equivalent to those of the aforementioned carriage assembly 16j.

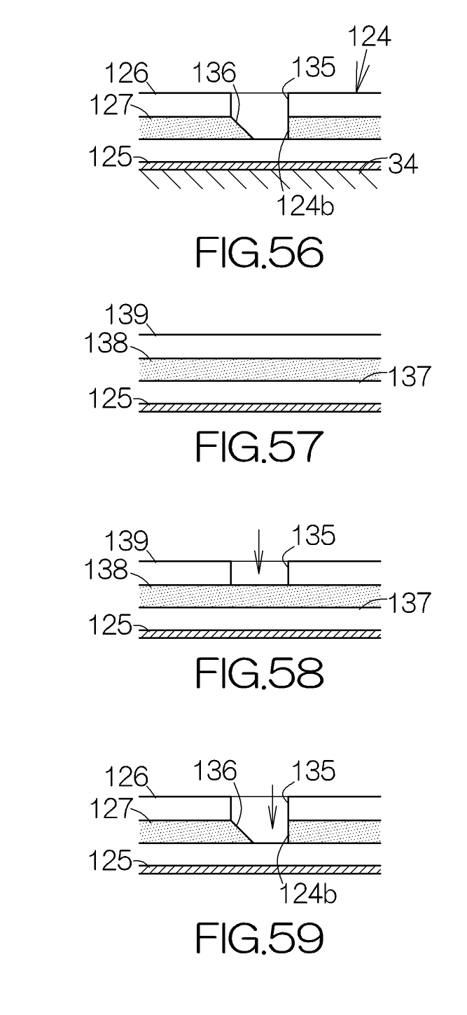

As depicted in FIG. 57, a photopolymer material 137 for a clad is applied on the support plate 125 at a constant thickness based on a spin coating technique, for example, for the production of the light waveguide 124. The photopolymer material 137 is hardened or cured in response to exposure to ultraviolet rays. A photopolymer material 138 for a core is applied on the photopolymer material 137 at a constant thickness based on a spin coating technique, for example. Ultraviolet rays are radiated to the photopolymer 138, for example. A mask is used to harden or cure the photopolymer material 138 in the shape of the core 127. A photopolymer material 139 is then applied on the photopolymer material 137. The photopolymer material 139 is hardened or cured in response to exposure to ultraviolet rays.

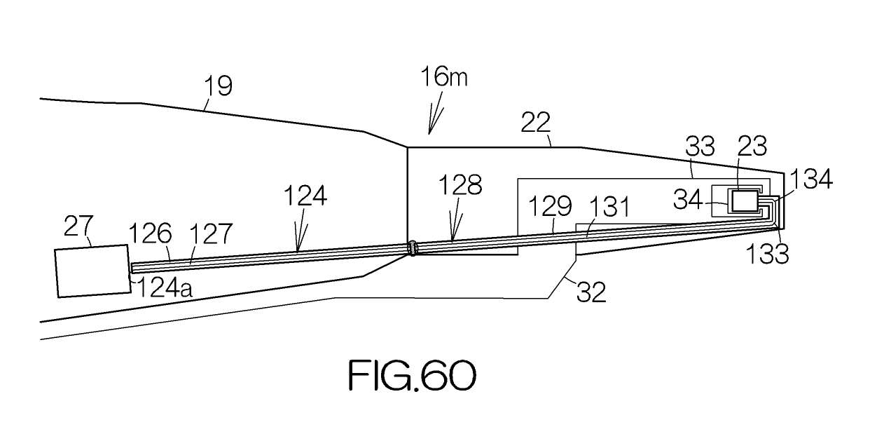

As depicted in FIG. 58, laser beams for processing are then applied to the photopolymer material 139. The photopolymer material 139 is in this manner removed from a predetermined area. This results in the formation of the opening 135 in the photopolymer material 139. The surface of the photopolymer material 138 is exposed inside the opening 135. Laser beams for processing are applied to the surface of the photopolymer material 138 inside the opening 135. This results in the formation of an inclined surface, namely the light-reflective surface 136, in the photopolymer material 138, as depicted in FIG. 59. Simultaneously, the light-output surface 124b is formed in the photopolymer material 138. Laser beams for processing are further applied to the light-reflective surface 136 for flattening the light-reflective surface 136. The light waveguide 124 is in this manner formed.

FIG. 60 schematically depicts a carriage assembly 16m according to a thirteenth embodiment. The carriage assembly 16m includes the light waveguide 124 and the light waveguide 128 placed on the carriage arm 19 and the head suspension 22, respectively. The light waveguide 124 is attached to the surface of the carriage arm 19. The light waveguide 128 may be formed on the head suspension 22 based on patterning. The end surface of the light waveguide 124 is opposed to the end surface of the light waveguide 128. An adhesive may be interposed between the end surfaces of the light waveguides 124, 128, for example. The end surfaces are in this manner bonded together. Like reference numerals are attached to the structure or components equivalent to those of the aforementioned embodiments.

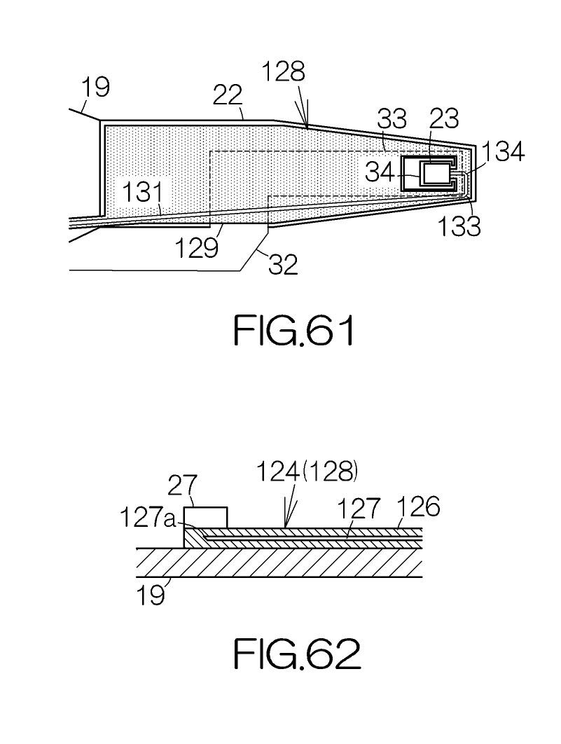

As depicted in FIG. 61, the clad 129 of the light waveguide 128 may extend over the entire surface of the head suspension 22. Laser may be employed to cut out the light waveguide 128, for example. A surface-emitting laser, such as a vertical cavity surface emitting laser (VCSEL), may be employed as the LD chip 27, as depicted in FIG. 62. Here, a light-reflective surface 127a may be formed on the core 127 of the light waveguide 124. The LD chip 27 may emit a light beam toward the light-reflective surface 127a.

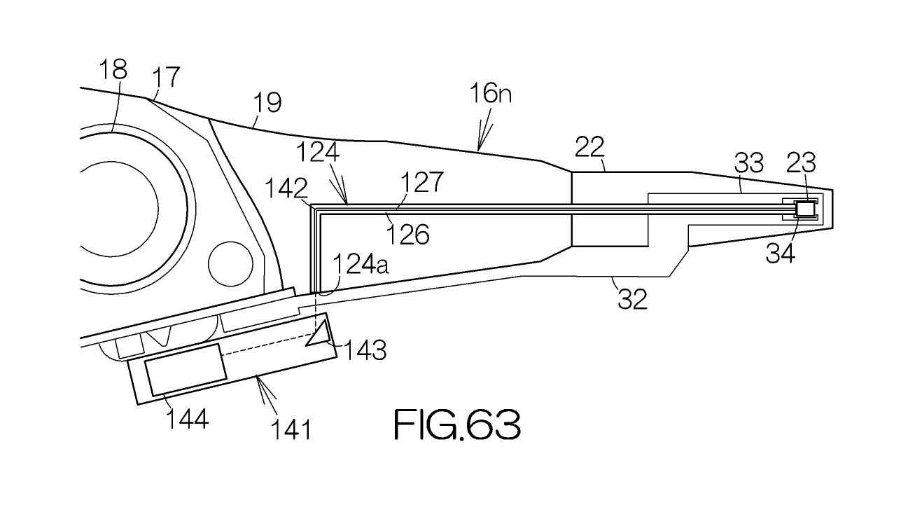

FIG. 63 schematically depicts a carriage assembly 16n according to a fourteenth embodiment. The carriage assembly 16n includes an optical module 141 attached to the side surface of the carriage block 17 for the supply of light. The optical module 141 directs light to the light-input surface 124a of the light waveguide 124. Here, the light waveguide 124 is bent to reach the outer periphery of the carriage arm 19. A light-reflective surface 142 may be formed on the core 127 at the bent area. The light-input surface 124a of the light waveguide 124 is opposed to a mirror 143 of the optical module 141. The mirror 143 is opposed to an optical unit 144 in the optical module 141. The mirror reflects a light beam output from the optical unit 144. The reflected light is directed to the input surface 124a.

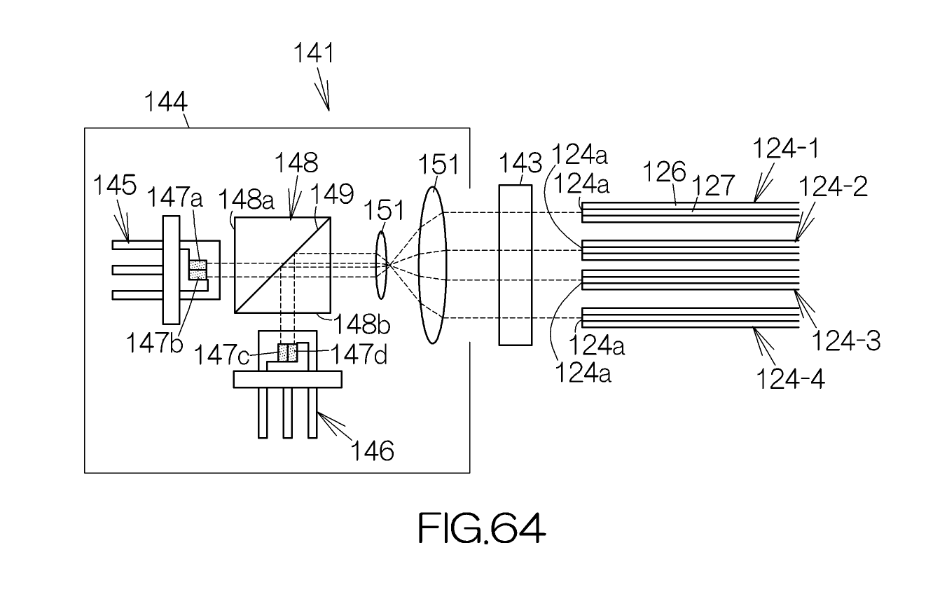

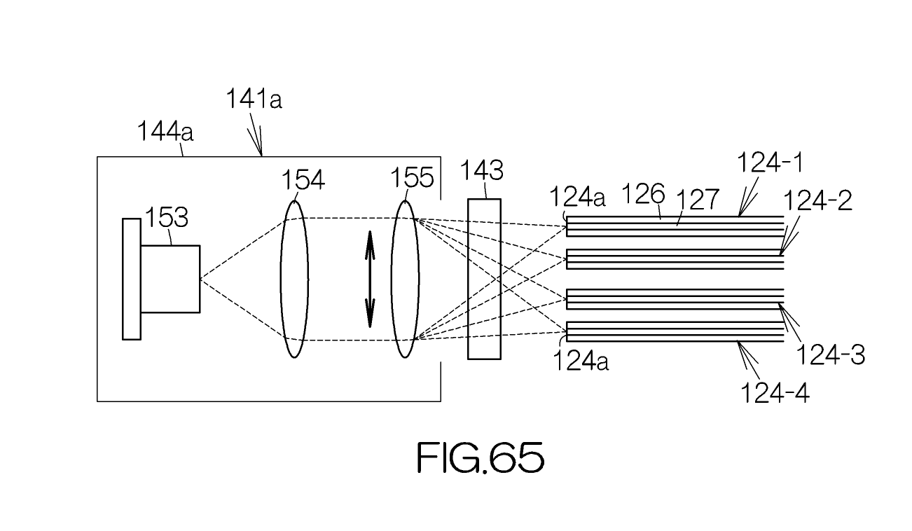

As depicted in FIG. 64, the optical unit 144 includes a first package laser diode (LD) 145 and a second package laser diode (LD) 146. The first package LD 145 and the second package LD 146 are placed on planes intersecting with each other at right angles, respectively. The first package LD chip 145 includes a first laser diode (LD) chip 147a and a second laser diode (LD) chip 147b arranged side by side. The second package LD chip 146 includes a third laser diode (LD) chip 147c and a fourth laser diode (LD) chip 147d arranged side by side. With the first to fourth LD chips 147a-147d, the present embodiment is applicable to two of the magnetic recording disks 14, for example.

A beam splitter 148 is opposed to the first package LD 145 and the second package LD 146. The first package 145 is opposed to a first light-input surface 148a of the beam splitter 148. The second package LD 146 is opposed to a second light-input surface 148b of the beam splitter 148. The first light-input surface 148a are set perpendicular to the second light-input surface 148b. The beam splitter 148 further has a light-reflective surface 149. The light-reflective surface 149 is configured to allows a so-called P-polarized beam to pass therethrough and to reflect a so-called S-polarized beam. A pair of objectives 151 are placed between the beam splitter 148 and the mirror 143. The objectives 151 serve to enlarge a light beam emitted from the LD chips 147a-147b. The beam splitter 148 and the objectives 151 serve as a switching mechanism.

The carriage assembly 16n includes the first to fourth LD chips 147a-147d assigned to the front and back surfaces of the magnetic recording disks 14, respectively. Here, light beams emitted from the first LD chip 147a and the second LD chip 147b passes through the light-reflective surface 149. Light beams emitted from the third LD chip 147c and the fourth LD chip 147d are reflected on the light-reflective surface 149. The light beam emitted from the second LD chip 147b passes through the light-reflective surface 149. The light beam is then refracted through the objectives 151, for example. The light beam is in this manner directed to the light-input surface 124a of the light waveguide 124-1 associated with the front surface of the upper magnetic recording disk 14. Likewise, the light emitted from the first LD chip 147a is directed to the light-input surface 124a of the light waveguide 124-3 associated with the front surface of the lower magnetic recording disk 14.

The light beam emitted from the third LD chip 147c is reflected on the light-reflective surface 149. The light beam is then refracted through the objectives 151. The light beam is in this manner directed to the light-input surface 124a of the light waveguide 124-2 associated with the back surface of the upper magnetic recording disk 14. Likewise, the light beam emitted from the fourth LD chip 147d is directed to the light input surface 124a of the light waveguide 124-4 associated with the back surface of the lower magnetic recording disk 14. In this manner, the first to fourth LD chips 147a-147d are individually assigned to the light waveguides 124. Accordingly, one of the first to fourth LD chips 147a-147d may be selected to emit a light beam for the writing of magnetic bit data. A mutual thermal influence is suppressed between the first to fourth LD chips 147a-147d. Like reference numerals are attached to the components or structure equivalent to those of the aforementioned embodiments.

As depicted in FIG. 65, an optical module 141a may be incorporated in the carriage assembly 16n. An optical unit 144a is incorporated in the optical module 141a. The optical unit 144a includes a single laser diode (LD) chip 153. A first objective 154 and a second objective 155 are placed between the LD chip 153 and the mirror 143. The second objective 155 is movable in the vertical direction parallel to the longitudinal axis of the support shaft 18, for example. The second objective 155 may be attached to a piezoelectric element for relative movement in the vertical direction, for example. The vertical movement of the second objective 155 serves to direct a light beam emitted from the LD chip 153 selectively to the light-input surfaces of the light waveguides 124-1 to 124-4. Here, the second objective 155 serves as a switching mechanism. Like reference numerals are attached to the structure or components equivalent to those of the aforementioned embodiments.

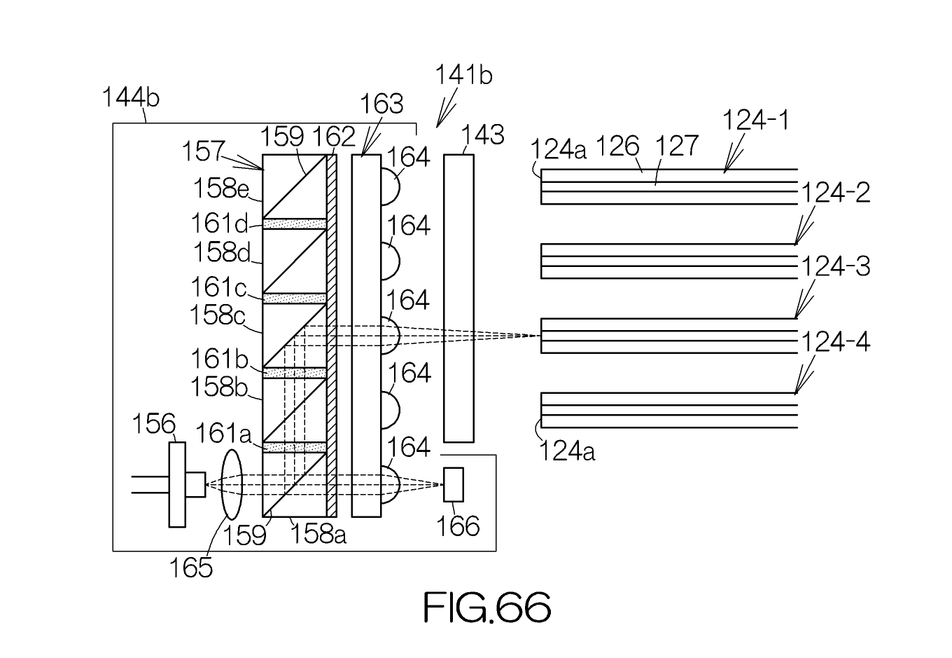

As depicted in FIG. 66, the optical module 141b may be incorporated in the carriage assembly 16n in place of any one of the optical modules 141, 141a. An optical unit 144b is incorporated in the optical module 141b. The optical unit 144b includes a single laser diode (LD) chip 156. A switching mechanism, namely a polarizing mechanism 157, is placed between the LD chip 156 and the mirror 143. The polarizing mechanism 157 includes first to fifth beam splitters 158a, 158b, 158c, 158d, 158e stacked on one another in the vertical direction parallel to the longitudinal axis of the support shaft 18, for example. The individual beam splitters 158a-158e define a light-reflective surface 159. The light-reflective surfaces 159 extend in parallel with one another. The individual light-reflective surfaces 159 are configured to allow the P-polarized beam to pass therethrough and to reflect the S-polarized beam. It should be noted that the first beam splitter 158a at the bottom of the stack has the permeability of 5% approximately. The fifth beam splitter 158e of the top of the stack has the permeability of 0%. Here, the fourth and fifth beam splitters 158d, 158e are assigned to the back and front surfaces of the upper magnetic recording disk 14, respectively. Likewise, the second and third beam splitters 158b, 158c are assigned to the back and front surfaces of the magnetic recording disk 14, respectively.

The polarizing mechanism 157 includes first to fourth liquid crystal (LC) panels 161a, 161b, 161c, 161d interposed between the adjacent ones of the beam splitters 158a-158e, respectively. The individual LC panels 161a-161d are configured to convert the P-polarized beam to the S-polarized beam. The polarizing mechanism 157 includes a half-wave plate 162 placed between the beam splitters 158a-158e and the mirror 143. The half-wave plate 162 is configured to convert the S-polarized beam to the P-polarized beam, for example. In the case where the P-polarized beam is optimal to the core 127 of the light waveguide 124, for example, the half-wave plate 162 may be placed. In the case where the S-polarized beam is optimal to the core 127, the half-wave plate 162 may be omitted. The polarizing mechanism 157 includes a lens group 163 placed between the half-wave plate 162 and the mirror 143. The lens group 163 includes lenses 164 opposed to the light-output surfaces of the beam splitters 158a-158e, respectively. The individual lenses 164 serve to converge a light beam.

The polarizing mechanism 157 includes a collimating lens 165 placed between the light-input surface of the first beam splitter 158a at the lowest position of the stack and the LD chip 156. The collimating lens 165 is configured to convert a light beam emitted from the LD chip 156 to a parallel P-polarized beam. The polarizing mechanism 157 includes a photodiode (PD) 166 opposed to the light-output surface of the first beam splitter 158a. The PD 166 is utilized for an auto luminous energy control. Since the first beam splitter 158a has the permeability of 5% approximately as described above, the light beam passes through the first beam splitter 158a to reach the photodiode 166. The photodiode 166 receives the light from the LD chip 156 for control to keep the luminous energy constant. Like reference numerals are attached to the structure or components equivalent to those of the aforementioned embodiments.

Now, assume that light is supplied to the light waveguide 124 assigned to the front surface of the lower magnetic recording disk 14, for example. The light beam emitted from the LD chip 156 is converted to the parallel P-polarized beam through the collimating lens 165. The P-polarized beam is input into the first beam splitter 158a. Since the light-reflective surface 159 has the permeability of 5% approximately, most of the P-polarized beam is reflected on the light-reflective surface 159. The P-polarized beam is thus input into the first LC panel 161a. The first LC panel 161a allows the P-polarized beam to pass therethrough. The P-polarized beam is input into the second beam splitter 158b. The light-reflective surface 159 of the second beam splitter 158b allows the P-polarized beam to pass therethrough. The P-polarized beam is thus input into the second LC panel 161b. The second LC panel 161b converts the P-polarized beam to the S-polarized beam. The S-polarized beam is input into the third beam splitter 158c. The S-polarized beam is reflected on the light-reflective surface 159 of the third beam splitter 158c. The S-polarized beam converges through the lens 164. The mirror 143 serves to direct the converging S-polarized beam to the light-input surface 124a of the light waveguide 124. In this manner, the light output from the single LD chip 156 can be directed selectively to the light-input surfaces 124a of the light waveguides 124.

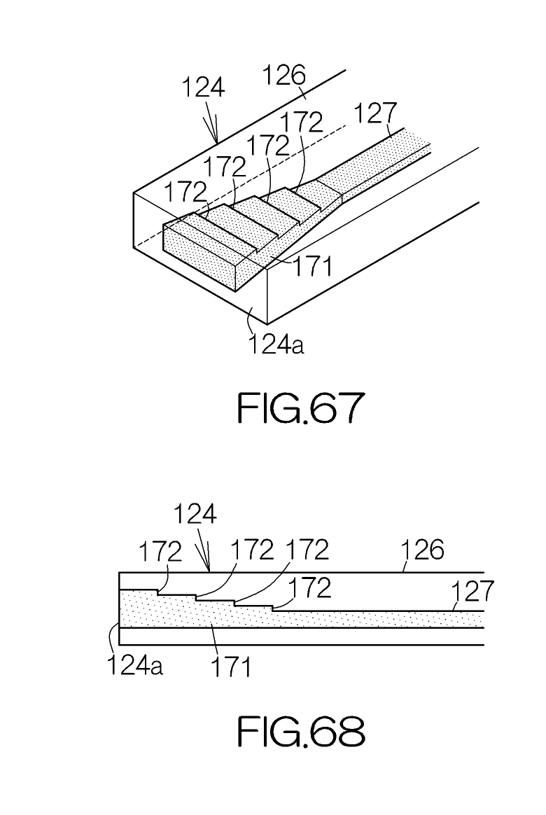

As depicted in FIG. 67, the core 127 of the individual light waveguide 124 includes a tapered portion 171 extending over a predetermined length from the light-input surface 124a toward the light-output surface 124b in the carriage assemblies 16i-16n. The tapered portion 171 has the largest opening at its proximal end and the smallest opening at its distal end. The tapered portion 171 gradually gets narrower both in the lateral direction of the core 127 and in the direction of height or thickness. Here, the core 127 has a rectangular cross-section, for example. Referring also to FIG. 68, steps 172 are formed on the upper surface of the core 127 so as to stepwise reduce the thickness of the core 127. The lateral length or width of the core 127 gets continuously reduced as the position gets farther from the light-input surface 124a. In other words, the side surfaces of the core 127 gets continuously closer to each other as the position gets farther from the light-input surface 124a. The length of the tapered portion 171 is set at 10 μm approximately, for example, from the light-input surface 124a.

Here, the tapered portion 171 has the dimension at the light-input surface 124a set equal to or larger than ten times the wavelength of light, that is, 5 μm approximately, for example. Such a light-input surface 124a enables establishment of a multi-mode beam. A single-mode beam is established at the distal end of the tapered portion 171. The tapered portion 171 allows the core 127 to have an enlarged opening at the light-input surface 124a. This results in an increase in a positional tolerance of the light beam relative to the core 127. The input light beam can thus be aligned with the core 127 in a relatively facilitated manner. Like reference numerals are attached to the structure or components equivalent to those of the aforementioned embodiments.

A silica glass layer having a constant thickness is formed on a sheet of a borosilicate glass for the formation of the light waveguide 124, for example. The silica glass layer is contoured along the contour of the core 127. Etching is then effected on the silica glass layer. A resist is utilized during the etching. The formation of the resist film and the application of the etching are repeated to form the steps 172. The core 127 is in this manner formed. Subsequently, an RF sputtering technique may be effected on the sheet to deposit BK7 on the surface of the borosilicate glass in the same manner as described above. The sheet clad 126 is in this manner formed. This results in the formation of the light waveguide 124.

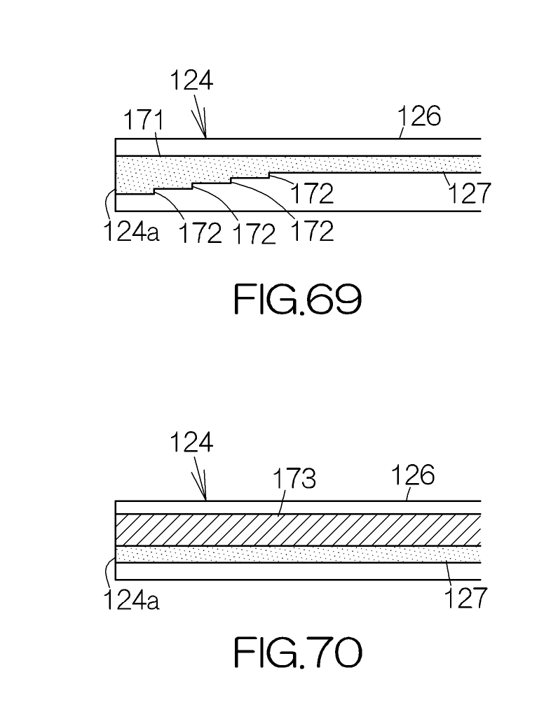

As depicted in FIG. 69, the steps 172 may be formed in the aforementioned light waveguide 124 on the lower surface of the core 127 for the formation of the tapered portion 171. The upper surface of the core 127 may be a flat surface. Like reference numerals are attached to the structure or components equivalent to those of the aforementioned embodiments. The light waveguide 124 is expected to enjoy the advantages identical to those obtained in the aforementioned embodiments. The steps 172 are formed on the surface of the sheet based on etching for the formation of the light waveguide 124. The core 127 is then formed on the sheet. Grinding process is applied to the upper surface of the core 127. An RF sputtering technique is effected on the core 127 to deposit BK7 on the surface of the sheet in the same manner as described above. The sheet clad 126 is in this manner formed. This results in the formation of the light waveguide 124.

As depicted in FIG. 70, a gradient index lens 173 may be formed in the aforementioned light waveguide 124 on the upper surface of the core 127 so as to achieve the function of the tapered portion 171. One end of the gradient index lens 173 is exposed at the light-input surface 124a of the core 127. The gradient index lens 173 is in direct contact with the core 127 over a predetermined length from the light-input surface 124a toward the light-output surface 124b of the core 127. The refractive index of the gradient index lens 173 gradually increases as the position gets closer to the core 127. The gradient index lens 173 has the length of 10 μm approximately in the direction of the transmission of light. Like reference numerals are attached to the structure or components equivalent to the aforementioned embodiments.

Since the refractive index of the gradient index lens 173 gradually increases as the position gets closer to the core 127 in the light waveguide 124, a light beam converges toward the core 127 through the gradient index lens 173. This results in an increase in a positional tolerance of the light beam relative to the core 127. The input light beam can thus be aligned with the core 127 in a relatively facilitated manner.

A silica glass is layered on the core 127 based on PECVD for the formation of the light waveguide 124. The growth rate of the silica glass may be adjusted. The adjustment of the growth rate enables a decrease in the refractive index as the thickness of the silica glass increases. The gradient index lens 173 is in this manner formed on the core 127. The sheet clad 126 is then formed on the gradient index lens 173. The growth rate may stepwise be adjusted. A layered body including plural layers may be overlaid on the core 127. In this case, as the position gets farther from core 127 in the layered body, the layer is configured to have a reduced refractive index.

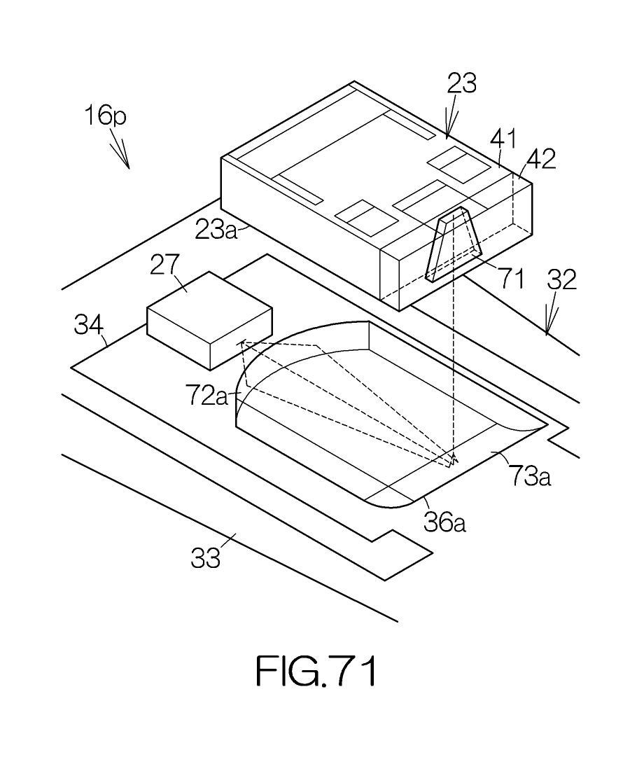

FIG. 71 schematically depicts a carriage assembly 16p according to a fifteenth embodiment. The carriage assembly 16p includes the LD chip 27 mounted on the support plate 34 of the flexure 32 at a position upstream of the flying head slider 23. The LD chip 27 may be soldered to the support plate 34, for example. Heat radiating fins, not depicted, may be interposed between the LD chip 27 and the support plate 34. The aforementioned coupler element 36a is interposed between the supported surface 23a of the flying head slider 23 and the support plate 34. The LD chip 27 emits a light beam toward the light-collecting surface 72a. Like reference numerals are attached to the structure or components equivalent to those of the aforementioned embodiments.

The carriage assembly 16p is allowed to enjoy the advantages identical to those obtained in the aforementioned embodiments. In addition, the heat of the LD chip 27 is transferred to the support plate 34 of the flexure 32. The coupler element 36a is interposed between the flying head slider 23 and the support plate 34. Since the coupler element 36a is made of a glass material or a plastic material, the transfer of the heat from the support plate 34 to the flying head slider 23 is minimized. This results in the prevention of a rise in the temperature of the flying head slider 23.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A head suspension assembly comprising:
a head suspension;
a head slider having a medium-opposed surface opposed to a storage medium, the head slider having a supported surface received on the head suspension, the supported surface being defined at a farside of the medium-opposed surface;
an electromagnetic transducer embedded in the medium-opposed surface of the head slider;
a light waveguide incorporated in the head slider, the light waveguide extending from the supported surface to the medium-opposed surface; and
an optical element interposed between the supported surface and the head suspension, wherein
the optical element defines:
a light-collecting surface configured to collect light input into the optical element in parallel with the supported surface; and
a light-reflective surface configured to reflect the light at a predetermined angle so as to direct the light to the light waveguide.

2. The head suspension assembly according to claim 1, wherein the electromagnetic transducer includes a write head element placed at a position downstream of the light waveguide.

3. The head suspension assembly according to claim 2, wherein the light waveguide is embedded in a non-magnetic insulating layer having a surface receiving the write head element, the non-magnetic insulating layer having a first refractive index, the light waveguide being made of a material having a second refractive index larger than the first refractive index.

4. A carriage assembly comprising:
a carriage arm pivotally supported on a support shaft;
a pair of head suspensions attached to a tip end of the carriage arm;
head sliders having medium-opposed surfaces opposed to storage media, respectively, the head sliders having supported surfaces received on the head suspensions, respectively, the supported surfaces being defined at a farside of the medium-opposed surfaces, respectively;
electromagnetic transducers embedded in the medium-opposed surfaces of the head sliders, respectively;
light waveguides incorporated in the head sliders, respectively, the light waveguides extending from the supported surfaces to the medium-opposed surfaces, respectively;
optical elements interposed between the supported surfaces and the head suspensions, respectively, the optical elements having light-collecting surfaces receiving an incidence of light to direct the light to the light waveguides, respectively;
an opening formed in the carriage arm;
a single support body placed in the opening, and
a pair of light sources supported on the support body, the light sources supplying light respectively to the light-collecting surfaces of the optical elements.

5. The carriage assembly according to claim 4, wherein each of the electromagnetic transducers includes a write head element placed at a position downstream of a corresponding one of the light waveguides.

6. The carriage assembly according to claim 5, wherein each of the light waveguides is embedded in a non-magnetic insulating layer having a surface receiving the write head element, the non-magnetic insulating layer having a first refractive index, the light waveguides being made of a material having a second refractive index larger than the first refractive index.

7. A storage apparatus comprising:
an enclosure;
a carriage arm incorporated in the enclosure, the carriage arm pivotally supported on a support shaft;
a pair of head suspensions attached to a tip end of the carriage arm;
head sliders having medium-opposed surfaces opposed to a storage medium, respectively, the head sliders having supported surfaces received on the head suspensions, respectively, the supported surfaces being defined at a farside of the medium opposed surfaces, respectively;
electromagnetic transducers embedded in the medium-opposed surfaces of the head sliders, respectively;
light waveguides incorporated in the head sliders, respectively, the light waveguides extending from the supported surfaces to the medium-opposed surfaces, respectively;
optical elements interposed between the supported surfaces and the head suspensions, respectively, the optical elements having light-collecting surfaces receiving an incidence of light to direct the light to the light waveguides, respectively;
an opening formed in the carriage arm;
a single support body placed in the opening; and
a pair of light sources supported on the support body, the light sources supplying light respectively to the light-collecting surfaces of the optical elements.

8. The storage apparatus according to claim 7, wherein each of the electromagnetic transducers includes a write head element placed at a position downstream of a corresponding one of the light waveguides.

9. The storage apparatus according to claim 8, wherein each of the light waveguides is embedded in a non-magnetic insulating layer having a surface receiving the write head element, the non-magnetic insulating layer having a first refractive index, the light waveguides being made of a material having a second refractive index larger than the first refractive index.

10. A head suspension assembly comprising:
a head suspension;
a head slider having a medium-opposed surface opposed to a storage medium, the head slider having a supported surface received on the head suspension, the supported surface being defined at a farside of the medium-opposed surface;
an electromagnetic transducer embedded in the medium-opposed surface of the head slider;
a light waveguide incorporated in the head slider, the light waveguide extending from the supported surface to the medium-opposed surface; and
an optical element interposed between the supported surface and the head suspension, wherein
the optical element defines:
a light-collecting surface configured to collect light input into the optical element in parallel with the supported surface; and
a light-reflective surface configured to reflect the light at a predetermined angle to direct the light to the light waveguide, the light having been input into the optical element through the light-collecting surface.

11. The head suspension assembly according to claim 10, wherein
the optical element defines:
a first flat surface received on the supported surface of the head slider;
a second flat surface extending in parallel with the first flat surface;
a first side surface connecting the first flat surface to the second flat surface, the first side surface getting farther from a first imaginary wall surface standing upright from a contour of the optical element as a position gets farther from a first reference plane extending in parallel with the first flat surface, the first side surface including the light-collecting surface; and
a second side surface connecting the first flat surface to the second flat surface, the second side surface opposed to the first side surface, the second side surface getting farther from a second imaginary wall surface standing upright from the contour of the optical element as a position gets farther from a second reference plane extending in parallel with the first flat surface, the second side surface including the light-reflective surface.

12. The head suspension assembly according to claim 10, wherein a focal point of the light is generated between the light-collecting surface and the light-reflective surface in the optical element.

13. The head suspension assembly according to claim 10, wherein the optical element defines a second light-reflective surface placed between the light-collecting surface and the light-reflective surface.

14. A head suspension assembly comprising:
a head suspension;
a head slider having a medium-opposed surface opposed to a storage medium, the head slider having a supported surface received on the head suspension, the supported surface being defined at a farside of the medium-opposed surface;
an electromagnetic transducer embedded in the medium-opposed surface of the head slider;
a light waveguide incorporated in the head slider, the light waveguide extending from the supported surface to the medium-opposed surface;
an optical element interposed between the supported surface and the head suspension;
a light-reflective surface defined in the optical element, the light-reflective surface reflecting light, having been input in parallel with the supported surface, at a predetermined angle to direct the light to the light waveguide; and
a gradient index lens supplying to the optical element light passing through the gradient index lens.

15. A head suspension assembly comprising:
a head suspension;
a head slider having a medium-opposed surface opposed to a storage medium, the head slider having a supported surface received on the head suspension, the supported surface being defined at a farside of the medium-opposed surface;
an electromagnetic transducer embedded in the medium-opposed surface of the head slider;
a light waveguide incorporated in the head slider, the light waveguide extending from the supported surface to the medium-opposed surface;
a sheet clad received on the head suspension; and
a core embedded in the sheet clad, the core reaching the supported surface of the head slider, the core configured to direct light to the light waveguide of the head slider.

16. The head suspension assembly according to claim 15, wherein the core is configured to bend so that the core supplies light near an outflow end of the head slider to the light waveguide.

17. The head suspension assembly according to claim 15, wherein the core defines a light-reflective surface reflecting light to the light waveguide, the light having been transmitted in parallel with the supported surface.

18. The head suspension assembly according to claim 15, wherein the core defines a tapered portion extending toward a light-output surface of the core over a predetermined length from a light-input surface of the core so as to narrow an aperture as a position gets farther from the light-input surface.

19. The head suspension assembly according to claim 15, further comprising a gradient index lens embedded in the clad over a predetermined length from a light-input surface of the core toward a light-output surface of the core at a position adjacent to the core, the gradient index lens having a refractive index getting larger as a position gets closer to the core.
